(19) United States
(12) Patent Application Publication
(10) Pub. No.: US 2026/0280926 A1
(43) Pub. Date: Sep. 17, 2026

(54) SYSTEM

(71) Applicant: SoftBank Group Corp., Tokyo (JP)

(72) Inventor: Yoshihiro HAYATA, Tokyo (JP)

(73) Assignee: SoftBank Group Corp., Tokyo (JP)

(21) Appl. No.: 19/550,361

(22) Filed: Feb. 26, 2026

Related U.S. Application Data
(60) Provisional application No. 63/771,095, filed on Mar. 13, 2025.

(51) Int. Cl. H04L 12/28; G06N 3/0455; G10L 13/08; G16Y 10/80; G16Y 40/20

(52) U.S. Cl. CPC H04L 12/282; G06N 3/0455; G10L 13/08; H04L 12/2825; G16Y 10/80; G16Y 40/20

(57) ABSTRACT

A system comprising a processor, wherein the processor is configured to: record an operation log of a home appliance, analyze the recorded operation log to determine an operational state of the home appliance, generate a voice signal based on a result of the analysis of the operation log, output the generated voice signal to a user, and communicate with other home appliances to share information with the other home appliances.

### CROSS-REFERENCE TO RELATED APPLICATION

This application claims the benefit of U.S. Provisional Application No. 63/771,095, filed on Mar. 13, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional home appliance management systems generally require a user to manually check the operating state of each appliance, to visually confirm error indications, and to individually operate power switches or control interfaces. Such systems often provide only limited feedback, for example by means of simple indicator lamps or text notifications on a small display, and do not provide intuitive, real-time voice guidance that directly informs the user of abnormal states or recommended actions. As a result, abnormalities such as a refrigerator door remaining open, excessive vibration of a washing machine, or unusual sound from a microwave oven may not be promptly detected or may be ignored by the user, leading to energy waste, accelerated wear, or product failure.

In addition, conventional systems do not sufficiently utilize operation logs and sensor data acquired from home appliances for advanced analysis. Although some systems can record basic logs, they often do not employ machine learning algorithms to learn normal operation patterns and to automatically set criteria for abnormality detection based on comprehensive data such as power consumption, environmental data, error codes, warning messages, and user operation histories. Therefore, the accuracy and adaptability of abnormality detection remain limited, and the system cannot flexibly respond to changes in user behavior, appliance aging, or environmental conditions.

Furthermore, existing systems typically lack seamless integration between multiple home appliances, such as smart door locks, air conditioners, and lighting devices, in order to provide cooperative energy-saving control based on user presence or absence. For example, when a smart door lock detects that the user has left the home, conventional systems often do not automatically propose power-off operations to the user through a voice interface, nor do they control appliance power based on the user's voice response. Consequently, there is a need for a system that can share information among appliances via a network, generate appropriate voice proposals, and control appliance power in accordance with user intent, thereby improving usability and energy efficiency.

Accordingly, there is a demand for a system that records detailed operation logs of home appliances, analyzes the logs using machine learning to determine operational states and to detect abnormalities with high precision, generates voice signals based on analysis results, outputs the voice signals to the user, and cooperates with other home appliances via a communication network. Such a system should enable prompt notification of abnormalities, intuitive interaction through voice guidance, and coordinated control of appliance power according to the user's situation and responses.

### SUMMARY

In order to solve at least part of the above-described problems, an aspect of the present invention provides a system comprising a processor, wherein the processor is configured to record an operation log of a home appliance, analyze the recorded operation log to determine an operational state of the home appliance, generate a voice signal based on a result of the analysis of the operation log, output the generated voice signal to a user, and communicate with other home appliances to share information with the other home appliances.

The processor records, as the operation log, data including at least a usage start time, a usage end time, power consumption, environmental data, an error code, a warning message, and a user operation history. The processor analyzes the recorded operation log by using a machine learning algorithm to learn a normal operation pattern based on the data and to set a criterion for detecting an abnormality. By learning the normal operation pattern for each home appliance and updating the pattern in accordance with accumulated logs, the processor can dynamically adapt the abnormality detection threshold to actual usage conditions and thereby improve detection accuracy for events such as abnormal temperature, excessive vibration, unusual sound, or irregular power consumption.

In one embodiment, the processor communicates with the other home appliances via the Internet, receives an out-of-home detection information from at least one of the other home appliances, causes generation of a voice signal that proposes turning off power of at least one home appliance to the user in response to the out-of-home detection information, receives a response of the user to the proposal, and controls power of the at least one home appliance based on the response of the user. For example, when a smart door lock detects that the user has left the home and transmits corresponding information, the processor generates a voice message such as a proposal to turn off an air conditioner or lighting, outputs the message through a speaker of a terminal, and interprets a voice response from the user. When the user approves the proposal, the processor issues a control command to turn off power of the corresponding home appliance via the communication function.

By combining recording of rich operation logs, machine-learning-based analysis of operational states, voice signal generation for intuitive user guidance, and network-based cooperation among multiple home appliances, the system according to the present invention enables early detection of abnormal operation, improves user convenience through voice interaction, and achieves coordinated energy-saving control in accordance with the user's situation and intentions.

The term “system” refers to an arrangement of hardware, software, and communication components that cooperatively execute the functions recited in the claims, including logging, analysis, voice generation, voice output, and communication among home appliances.

The term “processor” refers to any hardware component, or combination of hardware components, capable of executing instructions, including but not limited to a CPU, a microcontroller, an ASIC, an FPGA configured with processing logic, or a distributed set of such components operating together.

The term “operation log” refers to data recorded over time that represents the operating conditions and behavior of a home appliance, and that may include timestamps, power consumption, environmental data, error information, warning information, and user operation histories.

The term “home appliance” refers to any electrical or electronic device intended for use in a residential or similar environment, including but not limited to refrigerators, washing machines, microwave ovens, air conditioners, lighting devices, and smart door locks.

The term “operational state” refers to a condition of a home appliance determined based on one or more items of operation log data, such as normal operation, standby, error state, abnormal state, or energy-saving mode.

The term “voice signal” refers to data representing audio information that is suitable for output as speech to a user, and that may be generated by converting text into synthesized speech or by otherwise encoding voice content.

The term “voice output” refers to the process of converting a voice signal into audible sound and presenting the sound to a user through a speaker or other acoustic transducer.

The term “communication” refers to the exchange of data between the system and one or more external devices, including other home appliances, over a wired or wireless network such as the Internet, a local area network, or a short-range wireless link.

The term “other home appliances” refers to home appliances that are distinct from the particular home appliance whose operation log is being recorded or analyzed, and that are capable of exchanging information with the system via the communication function.

The term “usage start time” refers to a time value indicating when operation of a home appliance is initiated for a particular usage session.

The term “usage end time” refers to a time value indicating when operation of a home appliance is terminated for a particular usage session.

The term “power consumption” refers to an amount of electrical power or energy used by a home appliance during operation, which may be represented as instantaneous power, average power, or accumulated energy over a period.

The term “environmental data” refers to information related to the environment in which a home appliance operates, including but not limited to temperature, humidity, ambient noise level, or other measurable environmental parameters.

The term “error code” refers to a code or identifier generated by a home appliance or by the system to indicate a specific error condition or fault detected during operation.

The term “warning message” refers to information indicating a potential problem, risk, or suboptimal condition related to the operation of a home appliance, which may precede or accompany an error condition.

The term “user operation history” refers to recorded information about actions taken by a user with respect to a home appliance, such as button presses, setting changes, mode selections, or responses to system proposals.

The term “machine learning algorithm” refers to a computational method that automatically adjusts internal parameters or models based on training data, so as to learn patterns or relationships in the data without being explicitly programmed with fixed rules.

The term “normal operation pattern” refers to a representation, learned or defined by the system, of the typical or expected behavior of a home appliance under normal conditions, including ranges or distributions of operation log values.

The term “criterion for detecting an abnormality” refers to one or more thresholds, rules, or model outputs derived from the normal operation pattern, which are used to determine whether a current operational state should be classified as abnormal.

The term “abnormality” refers to a deviation of a home appliance's operational state from the normal operation pattern, such as excessive temperature, unusual vibration, irregular sound, unexpected power consumption, or recurring error codes.

The term “Internet” refers to a global network of interconnected computer networks that use standardized communication protocols to transmit data between devices, including the system and other home appliances.

The term “out-of-home detection information” refers to information indicating that a user has left a residence or a monitored area, which may be generated, for example, by a smart door lock, a security system, or a presence detection device.

The term “proposal to turn off power” refers to a suggestion presented to the user, typically via a voice signal, that recommends deactivating or reducing power to at least one home appliance for purposes such as safety, energy saving, or abnormality mitigation.

The term “user response” refers to input provided by the user in reaction to a proposal or notification, including but not limited to voice commands, confirmations, rejections, or requests for additional information.

The term “control power” refers to the act of changing or setting the power state of a home appliance, such as turning the appliance on or off, switching it to a standby mode, or adjusting its power level or operating mode.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

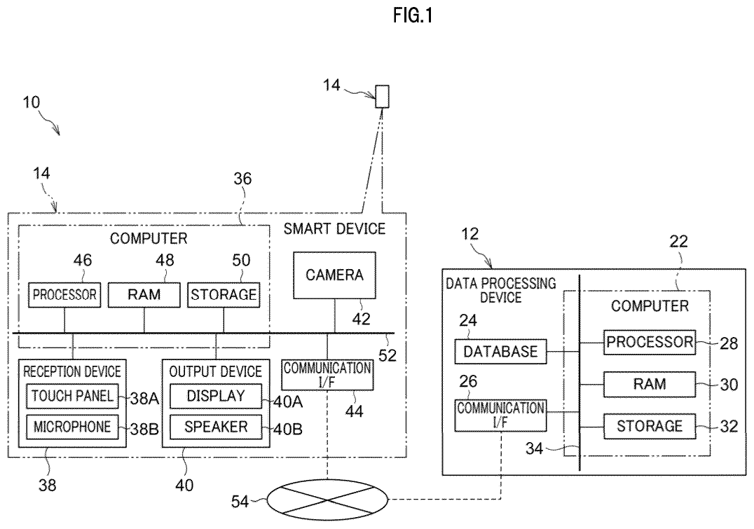

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

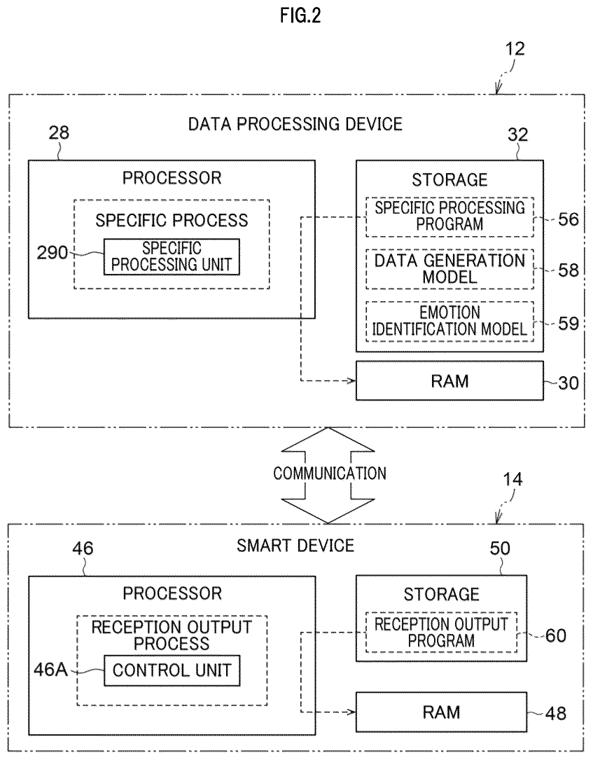

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional appliance management systems primarily rely on fixed rule sets and statically defined notification logic implemented in software modules on general-purpose processors. Such systems suffer from several technical drawbacks. First, because the anomaly detection thresholds and decision logic are hard-coded or tuned manually, the processor must repeatedly execute sub-optimal analysis routines over increasing volumes of operation information, resulting in unnecessary computation, higher memory usage, and degraded responsiveness as the system scales. Second, the generation of user-facing messages is often separated from the underlying analysis pipeline and implemented as simple template substitution, which forces the processor to maintain multiple redundant code paths and message variants for different contexts and languages. This leads to increased program complexity, code size, and maintenance overhead, and makes dynamic adaptation of notifications to new sensor patterns or device behaviors technically difficult. Third, when the operating environment or device usage patterns change, it is necessary to redeploy revised software or reconfigure parameters manually, because conventional systems lack a structured mechanism for the processor to automatically obtain and integrate improved analysis configurations and notification expressions from an external intelligent component. This limits the ability of the computing system to evolve its own analysis and output logic based on the accumulated operation information, thereby constraining overall system efficiency and scalability.

In addition, existing systems typically treat communication with external machine learning services, if present, as a one-off inference step (for example, a simple classification), without tightly integrating such services into the feedback loop for updating both the anomaly detection logic and the user notification logic. As a result, the processor repeatedly executes legacy analysis routines even when more suitable analysis structures or message formulations could be obtained from external models, and cannot systematically refine its processing pipeline based on the characteristics of the actual operation information and measured device states. Consequently, the computing architecture does not fully utilize the potential of generative models to reduce processing redundancy, improve anomaly detection efficiency, and generate user notifications that are both compact for transmission and effective for guiding user actions.

Therefore, there is a need for an improved computer-implemented system in which a processor is configured not only to collect and analyze operation information and generate audio notifications, but also to interact programmatically with a generative AI model through structured prompt sentences. The processor should be able to obtain, integrate, and iteratively refine analysis configuration information and user-oriented explanatory information from the generative AI model, thereby improving the efficiency, adaptability, and technical performance of the anomaly detection and notification pipeline executed on the processor.

The specific processing by the specific processing unit 290 of the data processing device 12 in Example 1 is realized by the following means.

The present invention provides a server comprising a processor configured to acquire and record operation information relating to one or more apparatuses, transmit the operation information via a communication path, execute an analysis process including a learning process on the operation information to determine whether an operation state is a normal state or an abnormal state, generate explanatory information or proposal information for a user based on a determination result, generate audio data from the explanatory information or proposal information, and output the audio data via an output device, wherein the processor is further configured to construct and transmit, to a generative AI model, a prompt sentence that includes at least one of measurement information contained in the operation information, analysis results, and configuration constraints for an analysis process or a notification process, to receive response information from the generative AI model, and to update or correct at least one of configuration information for the analysis process and explanatory information for the user on a basis of the response information, and wherein the processor is additionally configured to acquire state information or behavior detection information from another apparatus via the communication path, generate operation change proposal information on a basis of the state information or the behavior detection information, output the operation change proposal information as the audio data, and control an operation of at least one apparatus according to a user response to the operation change proposal information. This enables the processor to dynamically refine its anomaly detection thresholds and processing procedures, to reduce redundant computation in the analysis pipeline, to automatically optimize user-facing notification content and structure using the generative AI model, and to integrate cross-device state information into a unified control and notification framework, thereby improving the overall technical performance, scalability, and adaptability of the computer-implemented appliance management system.

The term “operation information” refers to information representing an operating condition or usage state of an apparatus, including but not limited to usage start time, usage end time, energy consumption information, environmental information, abnormality identification information, warning information, and user operation history information.

The term “apparatus” refers to any physical device or equipment whose operation is monitored or controlled by the system, including but not limited to household appliances, industrial machines, or other electrically operated devices.

The term “storage unit” refers to any hardware or logical component configured to store data, including but not limited to volatile memory, non-volatile memory, magnetic storage, optical storage, or database systems.

The term “communication path” refers to any wired or wireless communication link or network through which data is transmitted between the processor and another device or system, including but not limited to local networks, wide area networks, and the Internet.

The term “information processing apparatus” refers to any computing device or system, separate from or integrated with the processor, that is configured to receive, process, or generate information for use in the system.

The term “analysis process” refers to a sequence of computational operations executed by the processor on operation information, including but not limited to preprocessing, feature extraction, pattern recognition, anomaly detection, and state determination.

The term “learning process” refers to a computational procedure in which the processor adjusts parameters or models based on operation information so as to derive patterns, thresholds, or decision criteria for subsequent analysis.

The term “normal state” refers to an operating condition of an apparatus that matches or falls within expected patterns or ranges learned or defined by the analysis process.

The term “abnormal state” refers to an operating condition of an apparatus that deviates from expected patterns or ranges learned or defined by the analysis process, and that is determined by the processor to indicate a potential fault, inefficiency, or undesired behavior.

The term “explanatory information” refers to information generated by the processor that explains to a user an operation state, an abnormal condition, or a recommended action, in a form suitable for human understanding.

The term “proposal information” refers to information generated by the processor that proposes to a user a change in operation of an apparatus, such as turning an apparatus on or off or modifying an operating mode.

The term “audio data” refers to digital data representing sound signals that can be reproduced by an audio output device to present audible information to a user.

The term “output device” refers to any component capable of presenting information to a user, including but not limited to a loudspeaker, headphone, display with audio capability, or other audio output mechanism.

The term “prompt sentence” refers to an input sentence or structured text generated by the processor and provided to a generative AI model in order to request generation of explanatory information, configuration information, or other output content.

The term “generative AI model” refers to a computational model configured to generate text, configuration data, or other content in response to an input such as a prompt sentence, the model including but not limited to large language models and other machine learning models capable of generative processing.

The term “response information” refers to information returned from the generative AI model to the processor in response to a prompt sentence, including but not limited to natural language text, configuration parameters, or structured instructions.

The term “configuration information for the analysis process” refers to information specifying how the analysis process is to be executed, including but not limited to model structures, parameter values, thresholds, rules, and processing procedures used to analyze operation information.

The term “notification explanatory information” refers to explanatory information generated for the specific purpose of being provided to a user as a notification, including details of an abnormal state and a corresponding countermeasure action.

The term “state information” refers to information describing a current or recent operational, environmental, or contextual condition of an apparatus or environment, obtained via sensors, control logic, or external systems.

The term “behavior detection information” refers to information indicating a detected behavior or activity associated with an apparatus or a user, including but not limited to presence, absence, movement, or interaction events.

The term “operation change proposal information” refers to proposal information that recommends changing an operation of at least one apparatus based on state information or behavior detection information, such as proposing to turn off a device when a user leaves a location.

The term “user response” refers to information indicating a reaction or instruction from a user to a notification or proposal, including but not limited to voice input, button input, or graphical user interface interaction, which is interpreted by the processor as a command or acknowledgement.

In one embodiment, a server, a terminal, and a user cooperate to implement the claimed system. The server operates as an information processing apparatus with enhanced analysis and generative capabilities, the terminal operates as an interface between physical apparatuses and the server, and the user receives notifications and provides responses that influence operation of the apparatuses.

The terminal includes one or more sensors, a communication interface, a local storage unit, and a control circuit such as a microcontroller or system-on-chip. The terminal can be implemented, for example, by a smart appliance controller that includes a general-purpose central processing unit, a memory, and interfaces such as an I²C bus, an SPI bus, and general-purpose input/output lines. The terminal acquires operation information from attached sensors such as temperature sensors, humidity sensors, power measurement sensors, vibration sensors, and sound sensors. The terminal records the acquired operation information in a local storage unit such as a non-volatile memory or a local database.

The server includes at least one processor, a main memory, a non-volatile storage unit, and a network interface. The server executes programs implemented in a programming language such as C, C++, Java, or Python, running on an operating system such as a general-purpose server operating system. The server accesses a database system to store and retrieve operation information and analysis results. The server further accesses an external or internal generative AI model through a communication network. The generative AI model is, for example, a transformer-based neural network trained as a large language model and deployed on one or more computing devices that include a processor and an accelerator such as a graphics processing unit.

The server receives operation information transmitted from one or more terminals. The server stores the operation information in a structured format, for example in a time-series database or a relational database. The operation information includes, as abstracted upper-level concepts, temporal indicators such as usage start time and usage end time, resource consumption indicators such as energy consumption information, environment indicators such as environmental information, diagnostic indicators such as abnormality identification information and warning information, and interaction indicators such as user operation history information. The server indexes the operation information according to identifiers of apparatuses, sensor types, and time intervals.

The server executes an analysis process on the stored operation information. The server uses a combination of rule-based processing and machine learning processing. The server uses a learning process to learn a normal operation pattern. In one example, the server trains an anomaly detection model such as an autoencoder neural network. The autoencoder neural network includes an encoder part that compresses a sequence of sensor values into a lower-dimensional latent representation, and a decoder part that reconstructs the sequence from the latent representation. The server trains the autoencoder on historical operation information corresponding to normal operation states, by minimizing a reconstruction error computed by a loss function such as a mean squared error between observed sensor values and reconstructed sensor values.

The server uses training data consisting of sequences of feature vectors. Each feature vector includes normalized values derived from the operation information, such as normalized temperature, normalized energy consumption, normalized vibration magnitude, and normalized sound level. The server performs data preprocessing such as scaling, outlier removal, and segmentation into fixed-length time windows. During training, the server computes gradients of the loss function with respect to network parameters and updates the parameters using an optimization method such as stochastic gradient descent or an adaptive gradient method. The server repeats this process over multiple epochs until convergence criteria based on the loss function are satisfied.

After training, the server uses the autoencoder as part of the analysis process. The server inputs a sequence of recent feature vectors derived from operation information into the autoencoder and computes a reconstruction error for each sequence. The server compares the reconstruction error to a threshold value. The server considers sequences with reconstruction errors exceeding the threshold to correspond to abnormal states. The server determines the threshold by analyzing the distribution of reconstruction errors for normal training data, for example by selecting a percentile value. This use of a learned error distribution improves detection sensitivity and reduces false positive detections, thereby improving accuracy compared to simple fixed-rule approaches.

In another example, the server uses a tree-based anomaly detection algorithm such as an isolation-based method. The server constructs a model using operation information as input features, and the model assigns an anomaly score to new operation information. The server determines that an operation state is an abnormal state when the anomaly score exceeds a predefined or adaptively determined limit. The server optionally combines the results of the neural network-based analysis and the tree-based analysis using an ensemble decision rule, which increases robustness in the presence of sensor noise.

The server also executes rule-based checks. The server defines rules that operate on attributes in the operation information, such as rules indicating that if a temperature is above a certain limit for longer than a certain time and a door status is open, then the operation state is abnormal. The server executes these rules efficiently using vectorized operations or database queries. The server combines rule-based decisions and learning-based decisions to form a final determination of whether each operation state is normal or abnormal.

The server generates explanatory information and proposal information for the user based on the determination results. The server maintains templates or structured representations that specify elements to be included in explanatory information, such as a description of the detected abnormality, a possible cause, and a recommended countermeasure action. The server fills in the templates using values derived from the operation information and analysis results. This structured generation enables concise yet information-dense messages.

The server further communicates with a generative AI model to refine both analysis configuration information and explanatory information. The server constructs a prompt sentence that includes measurement information and analysis results in natural language form, along with explicit instructions describing the desired output format. For example, the server generates a prompt sentence such as:

“You are a home appliance assistant. Analyze the following anomaly and generate a concise voice notification for a non-technical user. Appliance: refrigerator. Current temperature: 12 degrees Celsius. Normal range: 1 to 7 degrees Celsius. Door status: open for 5 minutes. Detected issue: abnormal temperature rise due to door left open. Output: one or two sentences, polite, in English, instructing the user what to do.”

In another example, the server generates a prompt sentence such as:

“You are a home appliance assistant. Based on vibration sensor data, an anomaly detection process has flagged excessive vibration. Generate a short warning message in English that tells the user to stop the machine and redistribute clothes. Use simple language and one or two sentences.”

In addition, for optimizing analysis configuration information, the server generates a prompt sentence such as:

“Explain in detail how to design an anomaly detection algorithm using temperature sensor data from a refrigerator, and how to map detected anomalies to user-friendly voice notifications. Propose threshold selection rules and describe a method for adjusting the thresholds dynamically based on historical data.”

The server transmits the prompt sentence to the generative AI model through a network interface. The server receives response information from the generative AI model, which includes candidate notification texts and, for configuration prompts, candidate analysis strategies, suggested threshold values, or parameter adjustment rules. The server parses the response information and integrates acceptable parts into its configuration. For example, the server extracts specific numeric threshold recommendations and rule descriptions, stores them in configuration data structures, and updates internal analysis modules accordingly without manual reprogramming. This dynamic updating of configuration information allows the server to adapt to changes in device behavior and environment, thereby improving long-term detection performance and reducing the need for manual tuning.

The server ensures that the integration of generative responses follows deterministic rules. The server validates proposed thresholds against safety constraints, filters out responses that do not meet system policies, and logs changes for traceability. This structured interaction with the generative AI model goes beyond simple one-time inference; the server uses the generative AI model as a configurable co-processor for generating both human-readable messages and machine-readable configuration parameters, resulting in a technical improvement to the configuration management of the analysis pipeline.

The server converts generated explanatory information or proposal information into audio data. The server uses a text-to-speech engine running on a computing platform or accessible as a network service. The server specifies parameters such as language, speaking rate, and voice style. The server receives synthesized speech as a digital audio stream and encodes it into a format suitable for transmission over the communication path. The server records associations between alert identifiers and corresponding audio data in a database, enabling efficient retrieval and retransmission if necessary.

The terminal receives notification information or audio data from the server via the communication interface. The terminal uses a local audio playback subsystem to output the audio data to a speaker. In some embodiments, the terminal includes a digital-to-analog converter and an amplifier configured to drive the speaker. The terminal manages playback in accordance with user-defined volume settings and device states. For example, if the terminal controls an air conditioner, the terminal outputs a message such as “You seem to have left home. Would you like to turn off the air conditioner?” to the user in response to behavior detection information.

The user, upon hearing the audio output, may respond verbally or by using physical input elements. The terminal may include a microphone and a speech recognition engine. The terminal or the server processes the audio captured by the microphone using an automatic speech recognition algorithm, which converts the audio signal to text representing the user response. The terminal or server compares the recognized text with expected command patterns, such as “yes” or “no,” and generates a corresponding control command. The terminal or server then forwards the control command to an apparatus control unit via a local control interface such as a serial bus, relay output, or dedicated control protocol. This configuration enables the system to translate user responses into concrete changes in apparatus operation.

The server also receives state information and behavior detection information from other apparatuses, such as presence sensors or door lock systems. The server stores and correlates such information with the operation information. The server uses correlation rules and learning-based models to infer user presence or absence, and to predict when certain apparatus operations are likely unnecessary. The server generates operation change proposal information that prompts the user to confirm operations such as turning off apparatuses when the user leaves a location. By integrating cross-device state information and behavior detection information, the server can reduce unnecessary energy consumption and improve overall system efficiency.

The described system improves computer technology in several ways. First, the server reduces redundant computation by using learned models and dynamically updated thresholds instead of fixed, conservative rules. By maintaining and adjusting thresholds based on actual operation information and generative AI model suggestions, the server reduces the number of unnecessary anomaly checks and focuses processing resources on significant deviations. Second, the server improves data management by structuring operation information into normalized feature vectors and time windows, and by indexing such information for efficient retrieval and analysis. This structured data processing improves cache utilization, query performance, and scalability.

Third, the server improves communication efficiency by generating concise yet context-rich explanatory information and proposal information. Because the server uses generative AI support to compress relevant context into a small number of well-formed sentences, the server reduces the size of data that must be transmitted to terminals for user notifications, thereby lowering communication load, especially in wireless environments. Fourth, the server improves the precision of notifications by coordinating rule-based, learning-based, and generative text-based components. The server supplies machine-readable analysis configuration information that is not simply human-authored rules, but is tailored by generative AI output to the observed data distributions, leading to lower false alarm rates and improved user trust.

The system is not a mere automation of human decision-making. The server combines specialized data structures, learned models, and generative configuration suggestions in a way that a human operator would not feasibly execute in real time for numerous devices. The autoencoder and anomaly detection models operate on high-dimensional feature vectors at sub-second timescales, and the server updates model parameters and thresholds based on continuous streams of operation information. The use of a generative AI model to synthesize configuration information and explanatory information is integrated into an automatic feedback loop that adjusts model behavior according to measured system performance. This feedback loop enables adaptive optimization of detection logic and notification logic, and represents an improvement to the technical operation of the computing system itself. Multiple alternative embodiments are possible. In one variant, the server uses a recurrent neural network architecture instead of an autoencoder, in which the server processes sequential operation information using a sequence model and outputs a probability of abnormality at each time step. The server trains the recurrent neural network using supervised learning with labeled normal and abnormal data, and uses a cross-entropy loss function and gradient-based optimization. In another variant, the server employs a convolutional neural network applied to spectrogram representations of vibration or sound signals, providing improved detection capabilities for mechanical abnormalities. In yet another variant, the server uses a clustering algorithm to group operation information into patterns and assigns cluster-based anomaly scores.

The terminal may also vary. In some embodiments, the terminal performs part of the analysis process locally, for example computing intermediate feature values or preliminary anomaly scores, and transmits these to the server. This reduces communication bandwidth and allows the server to focus on more complex analysis and generative tasks. In other embodiments, the terminal includes a simplified generative AI model deployed locally to generate ultra-short messages in conditions where connectivity to the server is limited, while the server maintains a more comprehensive generative AI model for full-featured operation when connectivity is available.

Through such embodiments and variations, the server, terminal, and user cooperate to realize a system in which a generative AI model is used in a structured and technically grounded manner to enhance anomaly detection, notification generation, configuration management, and apparatus control, thereby providing improved technical performance in terms of accuracy, processing speed, computational efficiency, and communication efficiency over conventional systems.

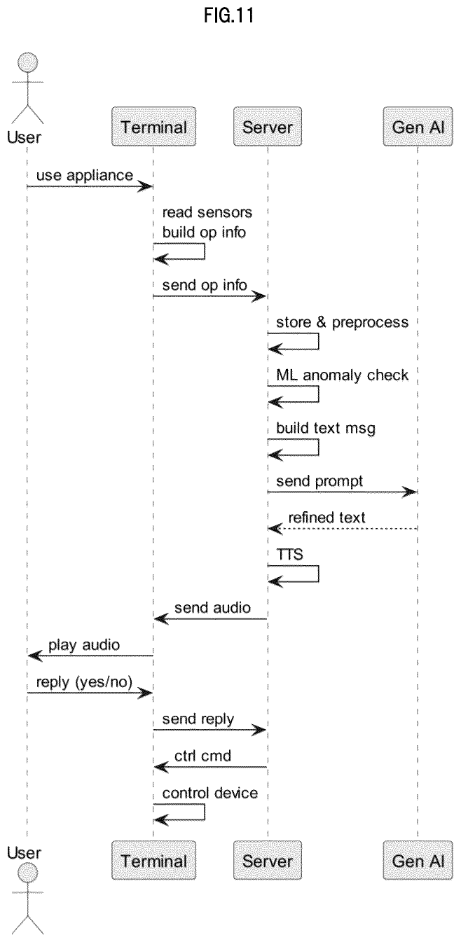

The following describes the processing flow using FIG. 11.

### Step 1:

The terminal acquires raw sensor data from an apparatus.

The terminal uses its control circuit to read electrical signals from attached sensors, such as temperature sensors, humidity sensors, power sensors, vibration sensors, and sound sensors, via interfaces including I²C, SPI, and GPIO.

Input: the terminal receives analog or digital sensor signals (for example, ADC counts, digital temperature codes, vibration samples).

Processing: the terminal converts raw signals into numeric values by applying calibration parameters and scaling factors stored in memory, such as converting ADC counts to degrees Celsius or watts using linear equations. The terminal aggregates these numeric values into a structured record together with a timestamp, an apparatus identifier, and a sensor type identifier.

Output: the terminal outputs a structured sensor record, for example a tuple containing [device_id, sensor_type, timestamp, measured_value].

### Step 2:

The terminal constructs operation information and records it locally.

The terminal combines multiple sensor records and context data to form operation information describing a usage state.

Input: the terminal receives structured sensor records from Step 1, as well as internal context such as operation mode, current cycle status, and last error code.

Processing: the terminal groups sensor records over a time window and computes derived attributes such as average temperature, total energy consumption over the window, door-open duration, or maximum vibration. The terminal attaches temporal indicators (usage start time, usage end time) and user operation history (button presses, remote commands) to form operation information. The terminal then serializes this operation information into a compact data structure, such as a JSON object or a binary record, and writes it to local non-volatile memory or a local database.

Output: the terminal outputs a stored operation information entry that can be retrieved and transmitted to the server.

### Step 3:

The terminal transmits operation information to the server.

The terminal uses a communication interface to send recently recorded operation information to the server.

Input: the terminal reads unsent operation information entries from local storage and a list of server endpoint parameters, such as a URL and security credentials.

Processing: the terminal formats selected operation information into a transmission payload, for example a batch of records encoded as JSON. The terminal establishes a secure connection to the server using a transport protocol and encrypts the payload. The terminal performs packet segmentation, error checking, and retransmission control if network errors occur.

Output: the terminal outputs a successfully transmitted payload containing operation information to the server and a local status flag marking the entries as sent.

### Step 4:

The server receives and stores operation information.

The server accepts incoming connections and parses the transmitted operation information.

Input: the server receives encrypted payloads from one or more terminals via a network interface.

Processing: the server decrypts each payload, verifies authentication tokens, and parses the structured operation information records. The server validates required fields (device_id, timestamps, sensor values) and rejects malformed entries. The server then stores the validated records in a database, indexing them by device identifier, sensor type, and time. The server may also transform values into normalized representations for efficient analysis, such as converting temperatures to a common unit or scaling numeric ranges.

Output: the server outputs database entries representing stored operation information, ready for analysis.

### Step 5:

The server constructs feature vectors and time windows for analysis.

The server prepares operation information for use as input to anomaly detection models.

Input: the server reads stored operation information records for a particular device and time interval from the database.

Processing: the server aligns records from different sensor types by time, interpolates missing values if necessary, and constructs feature vectors that include normalized attributes such as temperature, power, vibration magnitude, sound level, and environment indicators. The server then segments the sequence of feature vectors into fixed-length time windows, for example windows of 60 samples with an overlap. For each window, the server may compute additional statistical features such as mean, standard deviation, maximum, and minimum for each attribute.

Output: the server outputs a sequence of feature windows, each represented as a matrix or tensor suitable for input to a learning-based anomaly detection model.

### Step 6:

The server performs anomaly detection using a learned model.

The server uses a trained neural network or other machine learning model to detect abnormal states.

Input: the server receives feature windows from Step 5 and model parameters stored on disk, such as weights and biases of an autoencoder.

Processing: the server loads the model parameters into memory and performs forward passes of each feature window through the model. For an autoencoder, the server computes latent representations via the encoder part and reconstructs the input via the decoder part. The server then computes a reconstruction error for each window as a difference between input features and reconstructed features, using a loss function such as mean squared error. The server compares the reconstruction error against a threshold that has been previously derived from normal training data. When the reconstruction error exceeds this threshold, the server flags the corresponding time window as an abnormal state.

Output: the server outputs anomaly detection results, including for each time window a normal/abnormal label, an anomaly score, and associated metadata such as time interval and device identifier.

### Step 7:

The server applies rule-based checks and integrates results.

The server refines anomaly decisions by combining learned-model output with deterministic rules.

Input: the server receives anomaly detection results from Step 6 and the original operation information from the database.

Processing: the server applies rule definitions that operate on attributes such as temperature, duration, door status, and error codes. For example, the server checks whether temperature exceeds a setpoint for longer than a threshold while a door is open, or whether power consumption is inconsistent with the selected mode. The server then combines the rule-based conclusions with the learning-based anomaly scores using a decision policy, such as marking an event as abnormal if either the reconstruction error is high or a rule is triggered, or requiring both signals for critical alerts.

Output: the server outputs consolidated state determinations, specifying for each event or window whether the state is normal or abnormal, the probable cause, and a severity level.

### Step 8:

The server generates explanatory information and proposal information.

The server constructs user-facing descriptions based on the consolidated determinations.

Input: the server receives consolidated state determinations and associated operation information (e.g., current temperature, door state, vibration profile) from Steps 6 and 7.

Processing: the server selects a message template according to device type and anomaly type. The server fills placeholder fields in the template with specific values (e.g., current temperature 12 degrees, normal range 1-7 degrees, door open time 5 minutes) and constructs explanatory information that describes the detected abnormality and its likely cause. The server also constructs proposal information when a user decision is needed, such as a suggestion to turn off an apparatus or modify an operating mode.

Output: the server outputs structured explanatory information and proposal information records, each containing message text and associated parameters such as language and priority.

### Step 9:

The server constructs a prompt sentence for a generative AI model.

The server prepares a structured input text to request refined messages or configuration suggestions.

Input: the server receives explanatory information and proposal information from Step 8, along with current analysis configuration data and a target output specification (e.g., language, length).

Processing: the server concatenates relevant details into a coherent natural-language prompt sentence. For example, the server constructs:
“You are a home appliance assistant. Analyze the following anomaly and generate a concise voice notification for a non-technical user. Appliance: refrigerator. Current temperature: 12 degrees Celsius. Normal range: 1 to 7 degrees Celsius. Door status: open for 5 minutes.

Detected issue: abnormal temperature rise due to door left open. Output: one or two sentences, polite, in English, instructing the user what to do.”

The server may create other prompt sentences for configuration guidance, such as:
“Explain in detail how to adjust temperature anomaly thresholds dynamically based on recent sensor data so that false alarms are reduced while early detection is maintained.” Output: the server outputs a prompt sentence ready to be transmitted to the generative AI model.

### Step 10:

The server interacts with the generative AI model and updates messages or configuration.

The server uses the generative AI model to refine explanatory information and analysis settings.

Input: the server transmits the prompt sentence from Step 9 to the generative AI model and receives response information in text form.

Processing: the server parses the response information, which may include alternative message formulations and suggested parameter values or rules. For message refinement, the server selects a candidate notification sentence that meets length and style constraints and replaces or augments its initial message text. For configuration updates, the server extracts numeric thresholds or rule descriptions and writes them into configuration data structures used by the anomaly detection process. The server validates new values against safety constraints and logs the changes.

Output: the server outputs updated explanatory information ready for audio conversion and, if applicable, updated configuration parameters for future analysis.

### Step 11:

The server converts explanatory and proposal information into audio data.

The server uses a text-to-speech process to create audio notifications.

Input: the server receives finalized message text from Step 10 and audio output preferences such as language, voice type, and speaking rate.

Processing: the server calls a text-to-speech engine with the message text and parameters, and receives a digital audio stream representing synthesized speech. The server encodes or packages the audio stream into a specified format, such as a compressed audio file, and associates the file with an alert identifier. The server may normalize loudness and trim silence to optimize user experience and reduce data size.

Output: the server outputs audio data files or streams and mapping information from alert identifiers to corresponding audio resources.

### Step 12:

The server sends audio notifications and control proposals to the terminal.

The server delivers generated audio and related metadata to the appropriate terminal.

Input: the server receives audio data from Step 11, device identifiers, and any associated proposal information indicating that user confirmation is required.

Processing: the server determines the target terminal based on the device identifier and constructs a notification payload that includes either the audio data or a reference to the audio data, as well as metadata such as alert type, severity, and whether user input is needed. The server sends this payload to the terminal through a secure channel and monitors for delivery acknowledgments.

Output: the server outputs transmitted notification payloads and updated status records indicating that alerts have been delivered.

### Step 13:

The terminal plays the audio notification to the user.

The terminal presents the server-generated information to the user via audio output.

Input: the terminal receives the notification payload from Step 12, including audio data and metadata indicating required actions.

Processing: the terminal decodes the audio data if necessary and configures its audio playback subsystem according to user settings, such as volume level and do-not-disturb modes. The terminal then sends the decoded audio samples to a digital-to-analog converter and an amplifier connected to a speaker. During playback, the terminal may blink indicators or show a basic text summary if a display is available.

Output: the terminal outputs audible speech that informs the user of the detected condition and any proposed action.

### Step 14:

The user responds to operation change proposals.

The user listens to the notification and chooses whether to accept or reject the proposed action.

Input: the user receives the audio message from Step 13, such as “You seem to have left home. Would you like to turn off the air conditioner?”

Processing: the user decides on an action and either speaks a response (e.g., “Yes” or “No”) or uses a physical input such as a button or a touch panel. This human decision is not computed data but is captured as a signal by the terminal.

Output: the user outputs a response in the form of speech or physical input that will be captured by the terminal.

### Step 15:

The terminal captures the user response and issues a control command.

The terminal translates the user's response into a machine-readable command.

Input: the terminal receives the user's speech through a microphone or a button press through an input interface.

Processing: if the response is spoken, the terminal digitizes the audio signal and applies a speech recognition algorithm that outputs a text string. The terminal compares the recognized text with expected patterns (e.g., “yes”, “no”, “cancel”) and decides the corresponding action. If the response is a button press, the terminal maps the button state directly to a predefined command. The terminal constructs a control command message, such as a command to turn off an apparatus or to ignore the proposal, and forwards this message either to the server or directly to an apparatus control module via a local control interface.

Output: the terminal outputs a machine-readable control command that specifies the requested change in apparatus operation.

### Step 16:

The server or the terminal controls the operation of the apparatus.

The system applies the decided control action to the physical apparatus.

Input: the server or the terminal receives the control command from Step 15, including the target apparatus identifier and desired new state (for example, power off or mode change).

Processing: the terminal or the server sends a low-level control signal to the apparatus controller using a communication protocol supported by the apparatus, such as a serial bus command or a dedicated control message. The apparatus controller changes its internal state accordingly, for example disabling a compressor, stopping a motor, or adjusting a setpoint. The terminal records the new state as operation information, which will be included in subsequent transmissions to the server.

Output: the terminal outputs updated operational behavior of the apparatus and new operation information reflecting the executed control action.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional monitoring systems for assisted persons, such as elderly residents in care facilities, typically rely on fixed threshold rules or statically trained models that operate on limited subsets of sensor data. These systems often process physiological and behavioral data in isolation, without robust time-series modeling, individualized baselines, or adaptive refinement of detection logic. As a result, such systems tend to generate excessive false positives (for example, spurious fever or fall alerts caused by transient sensor noise or short-term spikes) and false negatives (for example, subtle health deteriorations or atypical falls that do not match preconfigured patterns), which degrades the reliability and usefulness of automated notifications. Furthermore, in many existing architectures, the logic for anomaly detection and alert generation is hard-coded into the software and cannot be easily updated or optimized in response to changing data distributions, sensor configurations, or operational requirements, without extensive manual redesign by specialists.

From a computer-technology standpoint, there is a need to improve how processor-based systems: (i) ingest and structure heterogeneous sensor logs (temperature, heart rate, respiration, motion, pressure, and related metadata) as time-series data; (ii) learn and update normal-state models tuned to individual assisted persons; (iii) integrate machine learning outputs with rule-based conditions to determine anomaly types and priorities; and (iv) systematically refine those models and conditions over time using higher-level feedback. Conventional systems do not provide a mechanism whereby a processor can automatically generate and transmit prompt sentences to a generative AI model, receive structured recommendations, and feed those recommendations back into configurable thresholds, feature extraction methods, model structures, and notification-generation rules in a closed improvement loop. This lack of an integrated adaptive optimization mechanism leads to static anomaly-detection performance and hinders continuous improvement of system accuracy and efficiency.

Therefore, there is a demand for a computer-implemented system and method that technically improve the way a processor processes operation logs of assisted persons by: unifying multi-modal health and behavior logs into a standardized time-series representation; learning and applying individualized normal-state models; generating context-aware notification texts and synthesized voice alerts based on anomaly types and frequencies; and leveraging a generative AI model via prompt sentences to automatically or semi-automatically tune internal analytical parameters and models. Such an improvement would reduce false alarms, reduce missed incidents, and enhance the overall technical performance and adaptability of health-state monitoring and notification systems implemented on processor-based platforms.

The specific processing by the specific processing unit 290 of the data processing device 12 in Application Example 1 is realized by the following means.

The present invention provides a server comprising a processor configured to acquire and record operation logs including biological information and behavioral information of assisted persons, to control communication with terminals so as to receive, via a network, the operation logs transmitted from the terminals, to store the operation logs as time-series data in a storage device, to analyze the operation logs by using a machine learning algorithm so as to learn normal health-state patterns and determine abnormal states based on a degree of deviation from the normal health-state patterns, to generate notification text according to a type and an urgency level of the abnormal states and to synthesize a voice signal based on the notification text, to cause the voice signal to be transmitted to at least one acoustic device or portable information device for output as an audio notification, and to transmit a prompt sentence to a generative AI model including statistical information of the operation logs, currently set abnormality detection conditions, and information on past false-alarm cases or missed-incident cases, to receive a response from the generative AI model, and, based on the response, to automatically or semi-automatically update at least one of thresholds, feature-extraction methods, model structures, and notification-generation rules used in the analysis. This enables the server to implement an adaptive computational pipeline that continuously refines anomaly detection and notification logic in response to real-time sensor data and historical system performance, thereby improving the technical accuracy, robustness, and efficiency of computer-implemented monitoring and voice-notification operations.

The term “system” refers to a combination of hardware and software components that cooperate to execute the claimed functions, including at least one processor, memory, communication interfaces, and peripheral devices.

The term “processor” refers to one or more hardware processing units, such as a central processing unit, a microcontroller, or a processing core, configured to execute instructions to perform the described operations.

The term “operation logs” refers to data records representing historical measurements and events related to assisted persons, including biological information, behavioral information, measurement times, and identification information, typically structured as time-series data.

The term “biological information” refers to data values representing physiological states of an assisted person, including at least temperature information, heart-rate information, and respiration-rate information.

The term “behavioral information” refers to data values representing physical activities or postures of an assisted person, including at least motion-pattern information and floor-pressure information indicative of movement, immobility, or falls.

The term “assisted person” refers to an individual whose health or safety is monitored by the system, such as an elderly resident or a person in need of care.

The term “terminal” refers to an electronic device configured to acquire sensor data from or near an assisted person and to transmit the resulting operation logs to the server, and may include a wearable device, a room-installed device, or a portable information device.

The term “server” refers to a computing apparatus, typically remote from the terminals, that receives, stores, and analyzes operation logs, generates notifications, interacts with a generative AI model, and controls distribution of voice signals.

The term “network” refers to a communication infrastructure that allows data transfer between the terminals and the server, and may include wired or wireless networks, local area networks, wide area networks, or packet-switched public networks.

The term “time-series data” refers to a sequence of data points indexed by time, where each data point corresponds to measurements or events recorded at a particular time or time interval.

The term “machine learning algorithm” refers to a computational method that automatically infers patterns or models from data, such as models for learning normal health-state patterns and detecting deviations indicative of abnormal states.

The term “normal health-state patterns” refers to statistical or model-based representations of typical biological and behavioral states for an assisted person, learned from historical operation logs by the machine learning algorithm.

The term “abnormal states” refers to conditions in which biological or behavioral information deviates from the corresponding normal health-state patterns beyond one or more thresholds, including at least fever, low heart rate, abnormal respiration, falls, and abnormal immobility.

The term “degree of deviation” refers to a measure indicating how far a current data value or pattern departs from a learned normal health-state pattern, such as a difference, a standardized score, or an anomaly score.

The term “notification text” refers to human-readable textual information generated by the processor, describing detected abnormal states, associated measurements, recommended responses, and urgency levels.

The term “urgency level” refers to an indication of the relative priority or criticality of an abnormal state, used to determine how quickly and prominently a notification should be presented.

The term “voice signal” refers to an audio signal obtained by synthesizing speech from notification text, suitable for playback by an acoustic device to deliver audible information to a user.

The term “acoustic device” refers to an apparatus capable of outputting sound based on a voice signal, including at least loudspeakers, headsets, or integrated audio output units of information devices.

The term “portable information device” refers to a handheld or mobile computing device that can receive and present notifications, including at least smartphones, tablet devices, or mobile terminals used by caregivers.

The term “generative AI model” refers to a machine-learned model configured to generate output information, such as natural-language text, in response to input prompt sentences, based on patterns learned from training data.

The term “prompt sentence” refers to a text input provided to the generative AI model, describing data characteristics, detection conditions, performance issues, or required improvements, and requesting guidance or proposals.

The term “statistical information of the operation logs” refers to aggregated data derived from operation logs, such as averages, variances, distributions, frequencies of events, and performance metrics related to abnormal-state detection.

The term “abnormality detection conditions” refers to configuration parameters used by the analysis, including thresholds, rules, and criteria that specify when a data value or pattern should be treated as an abnormal state.

The term “false-alarm cases” refers to instances in which the system generated an alert indicating an abnormal state that did not correspond to an actual abnormal condition for the assisted person.

The term “missed-incident cases” refers to instances in which an actual abnormal state or event occurred for the assisted person but the system failed to generate a corresponding alert.

The term “thresholds” refers to numerical or categorical limit values used to classify data or anomaly scores into normal and abnormal categories.

The term “feature-extraction methods” refers to algorithms or procedures for deriving informative descriptors or features from raw operation logs, such as trends, variances, or patterns used as inputs to the machine learning algorithm.

The term “model structures” refers to architectural definitions of machine learning models, including types of models, numbers of layers, connection patterns, and other configuration settings.

The term “notification-generation rules” refers to logic that determines how and when notification text is created, what content is included, and how urgency levels and recommended responses are assigned based on detected abnormal states.

The term “automatically or semi-automatically” refers to an updating mode in which the processor modifies parameters or configurations without human intervention or with limited human confirmation or approval based on suggestions from the generative AI model.

In the following embodiments, a server, a terminal, and a user cooperatively implement the claimed system. The same reference to a “processor” in the claims is concretely realized by one or more hardware processing units provided in the server and in the terminal. The user corresponds, for example, to a caregiver who receives voice notifications and interacts with user interfaces.

### A. Hardware and Software Configuration of Terminal and Server

The terminal uses one or more sensor interfaces and communication interfaces to obtain and transmit operation logs. The terminal includes, for example, a microcontroller or system-on-chip such as a general-purpose ARM Cortex-M class device or an application processor executing an embedded operating system or a mobile operating system. The terminal further includes:
at least one temperature sensor, such as a contact thermistor or infrared sensor embedded in a wearable housing;
at least one heart-rate sensor using an optical photoplethysmography principle;
at least one motion sensor, such as a passive infrared motion sensor or an ultrasonic proximity sensor, mounted in a room;
at least one pressure sensor, such as a load cell or force-sensitive resistor, embedded in a floor or in a bed;
an analog-to-digital converter and digital communication buses such as I²C or SPI for reading sensor outputs;
a communication module such as a wireless local area network interface, a short-range radio interface, or a mobile communication modem.

The terminal executes software including a real-time scheduler, a sensor driver layer, a local data-structuring module, and a communication client. The communication client uses, for example, a Transmission Control Protocol/Internet Protocol stack, a secure sockets library such as a Transport Layer Security implementation, and an application protocol such as Hypertext Transfer Protocol Secure or a message queuing protocol.

The server uses one or more processor units, system memory, non-volatile storage, and network interface controllers. The server executes, for example, a general-purpose operating system, a web application framework, a database management system such as a relational database, and a machine learning runtime environment such as an environment for executing numerical computation libraries and neural network frameworks. The server also uses a text-to-speech engine and a client library for communicating with a generative AI model.

### B. Structure of Operation Logs and Data Processing on the Terminal

The terminal acquires raw sensor readings and structures them into operation logs. The terminal defines a data structure in memory where each operation log entry includes:
a measurement timestamp in a high-resolution format such as a 64-bit time value;
an assisted-person identifier, such as a numeric or alphanumeric code;
a sensor-type identifier, indicating temperature, heart rate, respiration, motion, or pressure;
a measured value in a normalized engineering unit, such as degrees, beats per minute, breaths per minute, or pressure units;
a quality flag, such as a small integer or bit field indicating whether a measurement passed range checks and self-diagnostic checks.

The terminal uses calibration parameters stored in non-volatile memory to convert raw voltages or raw digital counts from sensors into engineering values. For example, the terminal multiplies a raw temperature sensor value by a gain factor and adds an offset to obtain a calibrated temperature. The terminal applies a digital low-pass filter, such as a moving average filter, to heart-rate and respiration sequences to reduce high-frequency noise. The terminal batches operation log entries into time windows, such as windows of several seconds or minutes, and serializes these batches into structured messages. The terminal formats the messages as text-based objects or compact binary records that contain:
a device identifier;
a list of (timestamp, sensor-type, value, quality) tuples;
an assisted-person identifier associated with the device.

The terminal encrypts these messages using Transport Layer Security and transmits them to the server over a network interface. This structured, batched format reduces communication overhead and improves computation efficiency on the server because the server can parse and process multiple related measurements at once.

### C. Data Storage and Time-Series Structuring on the Server

The server receives operation log messages from multiple terminals and parses the messages into internal data structures. The server validates each field, checks whether numeric ranges are plausible, and discards or flags evidently invalid entries. The server writes the validated entries into a time-series storage structure in a database. Each row or record in the database contains:
a timestamp field;
an assisted-person identifier;
a sensor-type field;
a value field;
a quality flag field.

The server creates database indices on the combination of assisted-person identifier and timestamp. This indexing enables efficient retrieval of sequences such as “all heart-rate values for a given assisted person in a last-time interval.” From the perspective of computer technology, this explicit time-series structuring and indexing improves query performance and reduces database scan load, which in turn reduces latency for anomaly detection computations.

### D. Machine Learning Model Configuration and Execution on the Server

The server executes a machine learning algorithm to learn normal health-state patterns. In one embodiment, the server uses a recurrent neural network, such as a long short-term memory network, trained as an autoencoder for time-series data. The server arranges, for each assisted person and sensor type, sequences of consecutive measurements, such as 60 values representing one hour of measurements at regular intervals. The server normalizes each sequence by subtracting the mean and dividing by the standard deviation computed per assisted person and sensor type.

The server passes the normalized sequences into the neural network, which consists of:
an input layer that receives vectors of sensor values;
one or more recurrent layers, such as long short-term memory layers, that learn temporal dependencies;
a bottleneck or latent representation layer of reduced dimension;
one or more recurrent or fully connected layers that reconstruct the input sequence from the latent representation;
an output layer that emits reconstructed sequences.

The server trains this network using an error function such as a mean squared error between the input sequence and the reconstructed sequence. The server uses a weight update method such as stochastic gradient descent or a variant with adaptive learning rates. The server iterates over historical operation logs labeled as normal or free of severe incidents. The result of this training is that the network learns a compact representation of typical temporal patterns for that assisted person.

When the server receives new sequences, the server computes reconstruction error for each time step. The server uses this error as an anomaly score. If the error exceeds a threshold, the server classifies the current state as abnormal. Because this approach captures temporal dependencies and person-specific patterns, it reduces false positives and false negatives relative to static thresholds, thereby improving detection accuracy and system performance.

In a further embodiment, the server uses additional models, such as:
a one-class support vector machine for detecting unusual distributions of combined sensor values;
a gradient-boosted decision tree ensemble for classifying specific event types based on features such as slope of temperature change, variance of heart rate, and duration of immobility.

The server fuses outputs from these models and rule-based checks using a decision logic module. The decision logic module combines anomaly scores by computing weighted sums or logical conditions and outputs a final abnormal-state classification and urgency level.

### E. Rule-Based Decision Logic and Non-Conventional Processing

The server supplements neural network outputs with rule-based logic that is not a simple codification of human judgment, but is designed to exploit the precise, high-frequency and multi-modal nature of the operation logs. For example, the server defines rules such as:
if a floor-pressure sensor sequence exhibits a sudden large negative derivative followed by near-zero variance for a minimum duration, and a motion sensor shows no detection in the same period, the server classifies the event as a potential fall, even if heart rate remains within a short-term normal range;
if temperature shows a monotonic upward trend over several hours, with a positive derivative above a certain rate, the server elevates urgency, because such a pattern suggests progressive fever rather than a transient spike;
if respiration rate standard deviation increases beyond a pre-learned threshold while heart rate simultaneously fluctuates, the server flags an abnormal respiration state even when instantaneous values remain numerically within nominal bounds.

These rules use time derivatives, variances, and cross-sensor correlations that human caregivers cannot reliably compute mentally. The server executes these rules continuously across all assisted persons using precise numerical operations on time-indexed arrays. This non-conventional and high-dimensional rule set exploits the computational characteristics of the server, thus providing improvements in detection precision and coverage beyond manual procedures.

### F. Notification Text Generation and Voice Synthesis

When the server detects an abnormal state, the server generates notification text. The server uses template strings, stored in a configuration repository, containing placeholders for variables such as assisted-person identifier, room number, measured values, anomaly type, and recommended action. The server retrieves the appropriate template based on the abnormal-state type and urgency level and substitutes current values into the placeholders. For example, the server generates a sentence such as:
“The assisted person in Room 203 has a body temperature of 38.2 degrees Celsius and an elevated heart rate. Please contact medical staff immediately.”

The server then invokes a text-to-speech engine by passing the generated notification text, voice parameters such as language and gender, and audio format parameters. The text-to-speech engine returns an audio file or audio stream. The server stores a reference to this audio and transmits a notification message containing the reference to the terminals associated with responsible caregivers.

The server thus not only performs text generation but also coordinates low-level audio data handling. This pipeline reduces the cognitive load on caregivers, ensures consistent phrasing across events, and provides an immediate audio output on terminals, which is particularly important when caregivers cannot visually monitor screens.

### G. Adaptive Improvement Using a Generative AI Model

The server uses a generative AI model as an auxiliary design and optimization tool for the anomaly detection and notification pipeline. The server generates a prompt sentence that includes structured technical information. For example, the server composes a prompt sentence such as:
“Please explain a method to analyze elderly residents' body temperature time-series data and detect abnormal temperature changes, and to generate voice notifications for care staff when an anomaly is found.”

The server may also generate a prompt sentence such as:
“Using data from floor-embedded pressure sensors and room motion sensors, please describe a process to detect falls in elderly residents and to notify care staff quickly by synthesized speech.”

In more advanced embodiments, the server incorporates quantitative statistics and performance metrics into the prompt, such as:
“Current fever alerts have a 20 percent false positive rate mainly due to short-term spikes. Please propose threshold-adjustment rules and time-windowing strategies to reduce false positives without delaying true alerts.”

The server transmits these prompt sentences to the generative AI model via an application programming interface. The generative AI model returns detailed natural language responses, which include algorithmic suggestions such as:
increasing minimum-duration windows for temperature elevation;
using median filters instead of simple moving averages for specific sensor types;
adding features such as the number of zero-crossings in motion data.

The server stores both the prompt sentences and the responses in a configuration and design database. A configuration module on the server parses the responses, identifies specific parameter changes or rule modifications, and proposes updates to thresholds, feature extraction methods, or model structures. In one embodiment, the server converts certain textual recommendations directly into configuration changes, such as modifying a threshold value in a rule set or activating additional preprocessing steps.

Because the server uses the generative AI model to explore a wide algorithmic design space and to optimize configuration for the specific sensor environment and statistical properties of the operation logs, the system improves machine learning performance and decision precision over time without requiring a human engineer to manually inspect all raw data. This constitutes an improvement to computer technology itself, namely, the processor's ability to automatically refine its own anomaly-detection and notification algorithms based on structured feedback loops.

### H. Technical Effects and Improvement of Computer Technology

The server improves processing speed and computational efficiency by using structured time-series storage and batch processing. Because the server retrieves sequences directly via indexed database queries, the server avoids full-table scans that would otherwise increase latency. The use of dedicated neural network architectures optimized for time-series compression, such as autoencoders, reduces the dimensionality of data while preserving characteristic patterns, which decreases the number of operations required per detection decision.

The server improves detection accuracy through the combination of learned normal-state models and rule-based logic based on derivatives, variances, and cross-sensor correlations. This hybrid approach reduces both false positives and false negatives compared to systems that only apply static thresholds or simple aggregate statistics. By parameterizing and updating anomaly thresholds per assisted person, the server adapts to individual baselines, which further refines precision.

The server also improves data management by maintaining clear separation between raw operation logs, derived features, model parameters, and alert records. Each category is stored with appropriate indices and metadata, which allows targeted data retrieval, auditing, and model retraining. This structured data management directly impacts system responsiveness and maintainability.

The server improves communication efficiency by batching operation logs and by controlling the volume of voice alerts with aggregation logic. For instance, the server merges multiple low-severity anomalies into a single alert when appropriate, thus limiting the number of messages transmitted to terminals and the number of voice notifications played. This reduces bandwidth usage and avoids overwhelming caregivers with redundant information.

These improvements are not limited to automating prior human tasks. The server performs computational operations on continuous, high-dimensional, and multi-modal data streams in a manner that human caregivers cannot replicate in real time, such as continuously updating neural network weights, computing reconstruction-error time-series, and adjusting high-dimensional feature extraction pipelines based on generative AI guidance. The system thereby enhances the internal functioning of the computing infrastructure, including model training, feature processing, and alert generation pipelines.

### I. Roles of Terminal and User and Alternative Embodiments

The terminal acquires sensor data and transmits structured operation logs. In some embodiments, the terminal performs preliminary feature extraction, such as computing local mean and variance of heart-rate sequences before transmission, to further reduce bandwidth and server computation. In other embodiments, the terminal stores operation logs locally when the network is unavailable and uploads them when connectivity is restored.

The user receives voice notifications on a portable information device and interacts with graphical interfaces to acknowledge alerts, input follow-up notes, or adjust allowable ranges within administrator-defined limits. The user's feedback is stored on the server as additional metadata associated with alerts. In some embodiments, the server uses such feedback to label data segments as true positives, false positives, or missed incidents for use in retraining the machine learning models.

In a further implementation, the server distributes updated model parameters or rule sets to terminals, so that terminals can perform certain anomaly checks locally. This reduces response time and server load, as obvious incidents such as sudden, large pressure impacts followed by immobility can be detected and announced even when network latency is high. In another embodiment, the server uses different neural network architectures for different sensor combinations. For example, a convolutional neural network may be applied to short, high-frequency segments of pressure signals to detect characteristic impact waveforms corresponding to falls, while a recurrent network is reserved for longer-term trends of temperature and heart rate. In yet another embodiment, the server employs data augmentation techniques during training, such as adding small amounts of noise to sensor sequences or warping time axes slightly, to make the learned models more robust to real-world variability. By providing these multiple embodiments and variations, the system allows flexible deployment in different facilities, with different sensor configurations and network conditions, while maintaining the same core technical approach: structured multi-modal time-series modeling, hybrid model-and-rule anomaly detection, adaptive configuration guided by generative AI models via prompt sentences, and automated generation and delivery of synthesized voice notifications. This collection of features supports the claimed invention and enables a person skilled in the art to implement the system in hardware and software.

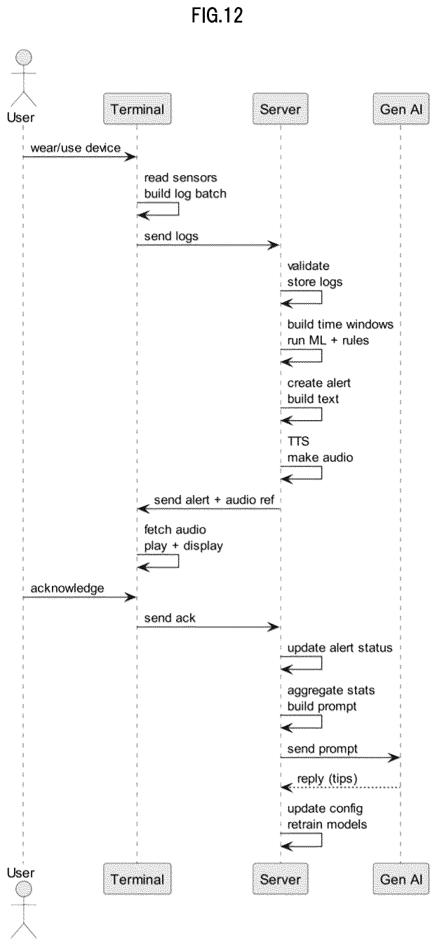

The following describes the processing flow using FIG. 12.

### Step 1:

The terminal acquires raw sensor readings.

The terminal receives, as input, electrical signals from temperature sensors, heart-rate sensors, motion sensors, and pressure sensors. The terminal converts analog signals into digital values using an analog-to-digital converter and reads digital sensor values over communication buses. The terminal then applies stored calibration coefficients to each raw value to compute engineering values such as degrees Celsius, beats per minute, motion intensity units, and pressure units. The terminal produces, as output, a set of calibrated measurements associated with sensor types and current timestamps.

### Step 2:

The terminal structures measurements into operation log entries.

The terminal receives, as input, the calibrated measurements and a resident identifier stored in local configuration. The terminal constructs, for each measurement, an operation log entry containing a timestamp, a resident identifier, a sensor-type identifier, a calibrated value, and an initial quality flag. The terminal checks whether each value lies within physically plausible limits and sets the quality flag to indicate validity or suspicion. The terminal produces, as output, a list of structured operation log entries in memory.

### Step 3:

The terminal performs local noise reduction and batching.

The terminal receives, as input, the list of operation log entries created in the previous step.

The terminal groups entries into short time windows, for example sixty-second windows, for each resident and sensor type. Within each window, the terminal computes smoothed values using a moving average or median filter and replaces noisy readings while preserving timestamps. The terminal packages all entries in the window into a batch object that contains device information and an array of log entries. The terminal produces, as output, a batched operation log ready for transmission.

### Step 4:

The terminal encrypts and transmits batched operation logs.

The terminal receives, as input, the batched operation log. The terminal opens a secure communication channel to the server by initiating a Transport Layer Security handshake using its communication interface. The terminal then serializes the batch into a message format and encrypts the message using session keys negotiated during the handshake. The terminal sends the encrypted message as a request to the server and waits for an acknowledgment. The terminal produces, as output, a transmitted message and an updated local transmission status for the batch.

### Step 5:

The server receives and validates operation log batches.

The server receives, as input, the encrypted message from the terminal. The server terminates the secure Transport Layer Security connection, decrypts the message, and parses the serialized batch into internal data structures. The server checks authentication tokens to confirm that the terminal is authorized, verifies the presence of required fields, and tests value ranges for plausibility. For each valid entry, the server sets or confirms the quality flag; for invalid entries, the server logs an error and may discard or mark them as invalid. The server produces, as output, a cleaned and validated operation log batch and an acknowledgment message returned to the terminal.

### Step 6:

The server stores validated operation logs in a time-series database.

The server receives, as input, the cleaned and validated log batch. The server converts each log entry into a database row with columns for timestamp, resident identifier, sensor type, value, and quality flag. The server inserts these rows into time-series tables and updates indices that organize records by resident identifier and timestamp. The server also updates summary statistics, such as running means and variances, per resident and sensor type. The server produces, as output, a persistent time-series data set and updated statistical profiles for use in analysis.

### Step 7:

The server constructs time-windowed sequences for analysis.

The server receives, as input, newly stored operation log entries and historical entries from the database. For each resident and sensor type, the server retrieves entries over a configured analysis window, for example the last thirty minutes. The server orders the entries by timestamp and interpolates or pads missing points to obtain fixed-length sequences. The server normalizes each sequence by subtracting the resident-specific mean and dividing by the resident-specific standard deviation stored in the statistical profiles. The server produces, as output, normalized time-windowed sequences suitable as input to machine learning models.

### Step 8:

The server applies machine learning models to detect anomalies.

The server receives, as input, the normalized time-windowed sequences. The server forwards these sequences to a trained neural network, such as a recurrent autoencoder, which reconstructs expected normal sequences. The server computes reconstruction error for each time step by subtracting the reconstructed value from the actual value and squaring and averaging over the sequence. The server compares the error against resident-specific thresholds to obtain an anomaly score and a preliminary normal-or-abnormal classification. The server produces, as output, anomaly scores and initial anomaly classifications for each analyzed sequence.

### Step 9:

The server evaluates rule-based conditions and fuses detection results.

The server receives, as input, the anomaly scores and classifications from the machine learning model and the underlying time-series data. The server computes derived features such as temporal derivatives, moving variances, and cross-sensor correlations over the same windows. The server evaluates a set of rules, for example rules for fall detection based on sudden pressure changes followed by immobility, or rules for sustained temperature increases. The server then combines the rule outputs with the anomaly scores using weighting or logical conditions to produce a refined abnormal-state decision and an urgency level for each resident. The server produces, as output, finalized abnormal-state types, severity levels, and supporting feature values.

### Step 10:

The server generates alert objects based on abnormal states.

The server receives, as input, the abnormal-state types and severity levels. The server creates an alert object containing a resident identifier, a timestamp, an abnormal-state category such as fever, low heart rate, abnormal respiration, fall, or abnormal immobility, the computed severity level, key sensor values, and recommended actions. The server checks recent alert history for the same resident to avoid redundant alerts and may aggregate similar events into a single alert if conditions allow. The server produces, as output, a set of alert objects ready for notification generation.

### Step 11:

The server composes notification text for each alert.

The server receives, as input, the alert objects. For each alert, the server selects a notification template based on abnormal-state category and severity and retrieves resident context such as room number. The server substitutes concrete values, such as current temperature and heart rate, into placeholders in the template to form a complete sentence. For example, the server converts “{room} temperature {temp}° C. high” to “The assisted person in Room 203 has a body temperature of 38.2 degrees Celsius.” The server optionally appends recommended actions and urgency indicators. The server produces, as output, one or more finalized notification text strings associated with the corresponding alerts.

### Step 12:

The server synthesizes voice signals from notification text.

The server receives, as input, the notification text strings. The server passes each text string and synthesis parameters, such as language and voice type, to a text-to-speech engine. The server receives back an audio representation, for example a waveform or compressed audio file. The server stores the audio file in a media repository and records a reference or uniform resource locator in the associated alert object. The server produces, as output, voice signals linked to alerts and ready for distribution.

### Step 13:

The server dispatches alerts and voice signals to terminals.

The server receives, as input, the alert objects containing notification text, severity, and audio references. The server determines the set of target terminals for each alert based on caregiver assignments and resident locations. The server constructs a notification message that includes alert metadata and either an embedded audio payload or a reference for audio retrieval. The server sends the message over network channels to the selected terminals, using push-notification services or message brokers. The server produces, as output, delivered notification messages and updated alert-delivery status records.

### Step 14:

The terminal presents visual alerts and plays voice notifications.

The terminal receives, as input, a notification message from the server. The terminal parses the message to obtain alert identifiers, resident information, severity, and either an audio payload or an audio reference. If a reference is provided, the terminal downloads the associated audio file from the server through a secure connection. The terminal invokes its audio playback interface to output the voice signal through speakers and simultaneously displays a visual alert showing text content and alert details. The terminal produces, as output, audible and visible notifications that inform the user of the detected abnormal state.

### Step 15:

The user acknowledges alerts and records follow-up information.

The user receives, as input, the audible and visual notifications shown by the terminal. The user reviews the displayed information and physically checks the resident as required. After taking action, the user operates the terminal interface to acknowledge the alert and optionally enters notes describing actions performed or observations made. The terminal packages this user input as an acknowledgment message containing the alert identifier, user identifier, timestamp, and note text. The terminal produces, as output, a structured acknowledgment message that is sent back to the server.

### Step 16:

The server updates alert status and logs caregiver responses.

The server receives, as input, the acknowledgment message from the terminal. The server locates the corresponding alert record and updates its status from pending or delivered to acknowledged, and stores the acknowledgment timestamp and user identifier. The server attaches the user's note as part of the alert history and derives performance metrics such as response time. The server produces, as output, an updated alert log that reflects closure of the event and data that can be used for later analysis and model refinement.

### Step 17:

The server constructs prompt sentences for the generative AI model.

The server receives, as input, aggregated statistics about operation logs and alert performance, such as false-alarm rate and missed-incident rate per category. The server selects one or more optimization objectives, for example reducing false positives for fever detection. The server composes a prompt sentence that describes current detection rules, machine learning model behavior, and observed weaknesses in natural language form. For example, the server constructs the text: “Current fever alerts have a 20 percent false positive rate mainly due to short-term spikes. Please propose threshold-adjustment rules and time-windowing strategies to reduce false positives without delaying true alerts.” The server produces, as output, prompt sentences ready for transmission to the generative AI model.

### Step 18:

The server queries the generative AI model and interprets responses.

The server receives, as input, the prompt sentences constructed for model improvement. The server sends each prompt sentence via an application programming interface to the generative AI model and receives a natural-language response containing algorithmic suggestions, parameter ranges, or rule modifications. The server parses the response to identify concrete elements, such as recommended time-window lengths, filter types, or new feature definitions. The server then maps these elements onto internal configuration items associated with thresholds, feature extraction, or model structures. The server produces, as output, candidate configuration updates derived from the generative AI response.

### Step 19:

The server updates analysis configuration and schedules retraining.

The server receives, as input, the candidate configuration updates proposed in the previous step. The server evaluates which updates fall within pre-approved adjustment ranges and applies those changes to configuration files or database tables controlling thresholds and rule parameters. For changes that affect model structure or major algorithm behavior, the server schedules new training jobs using stored operation logs as training data. The server updates model hyperparameters such as learning rates, window sizes, or latent dimensions according to the new configuration and executes training runs. The server produces, as output, modified thresholds, updated models, and revised rule sets that are deployed to the online analysis pipeline, thereby closing the adaptive improvement loop.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional home appliance monitoring systems typically employ fixed rule-based logic or static templates to generate notifications based solely on appliance operation states. In such systems, a processor usually analyzes operation logs to detect abnormal conditions and then outputs predetermined warning messages or simple synthesized speech. These architectures suffer from several technical limitations.

First, because the notification content is not dynamically adapted to a user's emotional state, the processor is forced to use generic, one-size-fits-all messages, which can increase user irritation or confusion. From a computing standpoint, the processing pipeline does not integrate multimodal user-related signals such as voice characteristics, operation behavior, and environment context into a unified state representation. As a result, the processor cannot utilize these data streams to optimize downstream processing, and the notification generation logic remains coarse and inflexible.

Second, conventional systems treat the speech synthesis stage as a simple, deterministic rendering of fixed text, instead of as part of an end-to-end computational pipeline that optimizes both the informational content and the style of output messages. The processor thus lacks the ability to control the notification generation process at a semantic level (for example, detail level, tone, or length) in response to changes in both appliance state and user state. This leads to inefficiencies in system operation, such as unnecessary repeated alerts, increased network usage due to redundant transmissions, and suboptimal user responses that require additional interactions or manual intervention.

Third, even when machine learning is used for anomaly detection on operation logs, the learned models are typically isolated from any generative process. The computing system does not systematically translate internal state estimates (for example, abnormality type, severity, user stress level) into machine-readable instructions for a generative AI model. In particular, there is no standardized mechanism within the processor to construct structured prompt sentences that encode the current machine state, user state, and output constraints, and then to feed those prompt sentences into a generative AI model as part of an integrated processing pipeline.

Fourth, existing architectures do not fully exploit the interaction loop between user responses and subsequent system behavior. User feedback, such as spoken responses or operation sequences after a notification, is rarely reintegrated into the computational pipeline to update emotion estimates and to refine later prompts and notifications. Consequently, the processor cannot iteratively improve its internal models and notification strategies during runtime, which limits the adaptability and responsiveness of the overall system.

Accordingly, there is a need for a computer-implemented system and method that (i) unifies operation log analysis and user emotion estimation within a single processing architecture, (ii) automatically generates structured prompt sentences that reflect both appliance operating states and user emotional states, (iii) uses a generative AI model to dynamically generate notification messages with controllable style and content, and (iv) closes the loop by feeding back user responses into the processing pipeline. Such a system should technically improve how the processor orchestrates data acquisition, state estimation, prompt generation, generative model invocation, and audio synthesis, thereby enhancing computational efficiency, flexibility, and robustness of the notification mechanism compared to conventional rule-based systems.

The specific processing by the specific processing unit 290 of the data processing device 12 in Example 2 is realized by the following means.

The present invention provides a server comprising a processor configured to record operation log data including time-series data and state data in a storage, analyze the recorded operation log data by using a machine learning algorithm to determine an operating state of an apparatus, estimate an emotional state of a user on a basis of voice data acquired from the user, operation history data of the user, and environment information, generate a prompt sentence to be input to a generative AI model in accordance with the operating state and the emotional state, input the prompt sentence to the generative AI model to acquire a notification message, generate an audio signal on a basis of the acquired notification message, and transmit the generated audio signal to a terminal for output to the user via a communication network. This enables the processor to implement an integrated, end-to-end computational pipeline that jointly processes appliance state data and user state data, dynamically constructs machine-readable prompt sentences, leverages a generative AI model to produce context- and emotion-adaptive notification messages, and synthesizes corresponding audio signals, thereby improving the technical operation of the server by enhancing flexibility, efficiency, and responsiveness of notification generation beyond conventional rule-based or template-based systems.

The term “operation log data” refers to data representing a history of operation of an apparatus, including at least time-series data and state data such as start time information, end time information, power consumption information, environment information, error information, warning information, and user operation history information.

The term “time-series data” refers to data in which measurement values or state values of at least one parameter are associated with respective time points or time intervals.

The term “state data” refers to data representing a logical or physical state of an apparatus or a system at a given time, including at least normal or abnormal states, error types, and operating modes.

The term “machine learning algorithm” refers to a numerical computation procedure that learns a relationship between input data and output data on a basis of training data and that estimates or classifies output corresponding to new input data, including at least statistical models and neural network models.

The term “operating state” refers to information indicating how an apparatus is currently operating, including at least whether the apparatus is in a normal operating state, an abnormal operating state, a standby state, or a stopped state, and further including an abnormality type and an urgency level.

The term “voice data” refers to data representing an acoustic signal obtained from a user or an apparatus by an audio input device, the data including at least digitized waveform samples or a file storing such samples.

The term “operation history data” refers to data representing a sequence of user operation events for controlling an apparatus, the data including at least event types, occurrence times, and target functions.

The term “environment information” refers to data representing an environment in which an apparatus or a terminal is installed, including at least time-of-day information, temperature information, humidity information, noise level information, and presence or absence of a person.

The term “emotional state” refers to information indicating a psychological condition of a user, including at least emotion labels such as irritation, confusion, anxiety, calmness, and satisfaction, and optionally including intensity values or stress levels.

The term “emotion estimation means” refers to a functional unit implemented by the processor and a storage, which unit is configured to estimate an emotional state of a user on a basis of at least voice data, operation history data, and environment information.

The term “prompt sentence” refers to text data including at least instructions, condition information, and situation descriptions to be input to a generative AI model, the text data describing at least an operating state, an emotional state, and one or more constraints on output such as style, information amount, or expression conditions.

The term “generative AI model” refers to an artificial intelligence model trained on large-scale data to generate content, including at least a language model that receives a prompt sentence as input and outputs text representing a notification message or another content.

The term “notification message” refers to text data that is generated in response to a prompt sentence by a generative AI model and that describes at least an operating state of an apparatus, an abnormality, a recommended action, or guidance for a user.

The term “notification message generation means” refers to a functional unit implemented by the processor and a storage, which unit is configured to generate a prompt sentence in accordance with an operating state and an emotional state, input the prompt sentence to a generative AI model, and acquire a notification message output from the generative AI model.

The term “audio signal” refers to digital or analog signal data representing sound that is suitable for driving an audio output device to output audible sound.

The term “audio generation means” refers to a functional unit implemented by the processor and a storage, which unit is configured to generate an audio signal on a basis of text data including at least a notification message.

The term “audio output means” refers to a functional unit implemented by a processor, a storage, and an audio output device, which unit is configured to output an audio signal as audible sound to a user.

The term “communication means” refers to a functional unit implemented by at least a processor, a storage, and a communication interface, which unit is configured to transmit and receive data including at least operation log data, voice data, operation history data, and notification messages via a communication network to and from an external apparatus.

The term “external apparatus” refers to a device other than the server or the terminal that is connected via a communication network and that is configured to provide or receive information, including at least another appliance, another terminal, or an external information processing apparatus.

The term “location state information” refers to data indicating a positional or presence-related state of a user or an apparatus, including at least information indicating whether the user is at home, outside, or in a particular area.

The term “behavior state information” refers to data indicating an activity or behavior pattern of a user, including at least movement, operation sequences, or usage patterns related to an apparatus.

The term “power state” refers to information indicating whether an apparatus is powered on, powered off, in a standby mode, or in another power-related mode.

The term “integrated computational pipeline” refers to a sequence of processing stages executed by a processor, including at least operation log analysis, emotion estimation, prompt sentence generation, generative AI model invocation, notification message post-processing, audio generation, and communication with a terminal.

In one embodiment, a server, a terminal, and a user cooperate to implement the system according to the above claims. The following description illustrates exemplary hardware and software configurations, data structures, algorithms, and processing flows that enable a person skilled in the art to implement the invention. Variations and alternatives may be adopted without departing from the scope of the claims.

### A. System Configuration

A.1 Terminal Hardware and Software

The terminal is an information processing apparatus that is attached to, or integrated into, a home appliance. The terminal includes at least:
A microcontroller or embedded processor, such as an ARM-based microcontroller.
A memory including a nonvolatile storage and a volatile storage.
A sensor interface unit that connects to a plurality of sensors, including at least:
A temperature sensor implemented as a digital temperature sensor on an I²C bus.
A vibration sensor implemented as a three-axis accelerometer connected via SPI.
A power sensor implemented as a current and voltage detection integrated circuit coupled to an analog input.
An acoustic sensor or a microphone connected to an analog-to-digital converter.
A communication module, such as a wireless local area communication module or a cellular communication module, implementing a TCP/IP stack.
An audio input/output interface including a microphone input circuit and a speaker output circuit.
A clock circuit such as a real-time clock.

The terminal executes an embedded operating system, such as a real-time operating system or an embedded general-purpose operating system. The terminal executes firmware programs written in a programming language such as C or C++, including:
A sensor acquisition module configured to periodically read raw sensor signals from the sensor interface.
A signal processing module configured to perform digital filtering, including moving average filtering and low-pass filtering, on measured values.
A logging module configured to structure and store operation log data in a memory.
A communication client module configured to compose and transmit messages to the server via a communication network.
An audio recording module configured to sample microphone input, buffer digital audio samples, and store audio files.
An audio playback module configured to decode audio data and drive the speaker.

By executing these modules, the terminal produces operation log data that include time-series data and state data suitable for subsequent analysis by the server.

### A.2 Server Hardware and Software

The server is an information processing apparatus that is deployed in a data center or a cloud environment. The server includes:
At least one general-purpose processor.
A main memory and a nonvolatile storage.
A communication interface for connecting to an external communication network.
Optionally, one or more hardware accelerators, such as graphics processing units, for accelerating numerical computation.

The server executes a server operating system, such as a generic server operating system, and a plurality of software components, including:
A Web server program.
An application server program that implements Web APIs.
A database management system that manages a relational database.
A file or object storage system for storing audio files and model parameters.
A numerical computation library for matrix and vector operations.
A machine learning library for training and inference of models such as recurrent neural networks, feedforward neural networks, autoencoders, and classifiers.
A natural language processing library for tokenization, embedding, and sequence modeling.
A speech synthesis engine for converting text into audio signals.
An API client for accessing a generative AI model, either locally deployed or provided as a network service.

The server stores trained model parameters and configuration data in the storage. The server loads such parameters into the main memory at runtime and performs inference by executing floating-point operations on the processor and, if available, the hardware accelerators.

### B. Data Structures

The server uses structured data records to represent operation log data, user-related data, and internal state.

The server stores operation log data as records having, for example, the following fields:
Appliance identifier and user identifier.
Start time and end time.
Time-series of temperature values, vibration values, power values, and sound levels, each associated with timestamps.
Aggregated metrics including average and maximum values for each sensor.
Error information and warning information including error codes and messages.
User operation history including a sequence of operation events (event type, timestamp, target function).
Environment information including at least ambient temperature, humidity, and time-of-day information.
References to voice data files recorded by the terminal.

The server stores emotional state data as records including:
Primary emotion label and secondary emotion label.
Emotion intensity values and stress level.
Confidence scores output by various models.

The server stores operating state data as records including:
State labels indicating at least normal, abnormal, standby, or stopped.
Abnormality type labels.
Urgency level.

The server stores prompt sentence data as text strings, and stores notification messages as text strings output by the generative AI model.

### C. Machine Learning-Based Analysis

### C.1 Appliance Operating State Analysis

The server analyzes operation log data using machine learning algorithms. For example, for temperature-based anomaly detection, the server uses a recurrent neural network model having a sequence of recurrent units configured to predict a next temperature value from a sequence of past temperature values.

The server implements the following functions:
The server normalizes raw temperature values by subtracting a mean and dividing by a standard deviation previously computed from training data.
The server inputs a sequence of normalized temperature values into an LSTM-based model. The model has one or more recurrent layers with a plurality of memory cells, each having gate structures including an input gate, a forget gate, and an output gate. The model parameters include weight matrices and bias vectors that are stored in the storage and loaded into the main memory for inference.
The server calculates a predicted temperature value for each time step and computes an error between the predicted value and the observed value. The server aggregates the errors along a time axis, for example by computing a mean squared error.
The server compares the aggregated error with a threshold stored in the database. If the error exceeds the threshold, the server sets the operating state to an abnormal state and sets an abnormality type corresponding to a likely cause, such as a door left open.

For vibration-based anomaly detection, the server uses an autoencoder model. The server extracts feature vectors from vibration signals by computing statistical values, such as root-mean-square values and peak values, and spectral values obtained from a Fourier transform. The autoencoder includes at least an encoder network and a decoder network. The encoder compresses input features into a latent representation, and the decoder reconstructs the original features. The server computes a reconstruction error and compares it with a threshold to detect abnormal vibration patterns.

For sound-based anomaly classification, the server extracts mel-frequency cepstral coefficients from sound recordings using an audio processing library. The server inputs these feature vectors into a classifier model such as a support vector machine or a neural network classifier to output labels indicating normal or abnormal acoustic signatures.

The server previously trains these models using historical operation log data. During training, the server defines a loss function, such as mean squared error for prediction or reconstruction tasks, or cross-entropy for classification tasks, and updates weights by gradient descent or a variant thereof. The server may apply data augmentation techniques, such as adding noise or time shifting, to improve robustness.

### C.2 Emotion Estimation

The server estimates a user's emotional state based on voice data, operation history data, and environment information.

The server performs the following processes:
The server transmits voice data to a speech recognition component implemented as an acoustic model and a language model. The acoustic model converts audio waveforms into sequences of phonetic units. The language model converts the sequences into character sequences. The server executes decoding algorithms, such as beam search, to obtain the most probable transcription.
The server inputs the transcription into a text-based emotion classifier. The classifier can be implemented as a neural network having:
An embedding layer that maps tokens to vector representations.
One or more sequence-processing layers such as recurrent layers or self-attention layers.
A classification layer that outputs probabilities for emotion classes such as irritation, anxiety, confusion, and satisfaction.
The server extracts prosodic features from the audio signals, including pitch contours, energy contours, and speaking rate, by computing short-time spectra and statistical summaries. The server inputs these features into a speech emotion recognition model, such as a convolutional neural network or a recurrent neural network, that has been trained to map prosodic patterns to emotion labels and intensity scores.
The server computes stress-related indicators from operation history, including the number of repeated operations, the count of emergency stops, and the frequency of mode changes within a specified time window. The server uses a model, such as a gradient-boosted decision tree, to map these indicators, combined with environment information, to a scalar stress score. The server integrates the outputs of the text-based and speech-based emotion models and the stress score. The server executes a fusion function, such as a weighted sum or a small neural network that takes the individual model outputs as input and outputs a final emotional state label and intensity. By combining heterogeneous signals, the server improves emotion estimation accuracy and robustness, thereby enhancing the reliability of subsequent processing.

### D. Prompt Sentence Generation and Generative AI Invocation

### D.1 Prompt Sentence Generation

The server synthesizes an explicit prompt sentence on the basis of the operating state and the emotional state. The server uses a template engine or string concatenation logic to embed state values and control parameters into a text.

The server, for example, constructs a prompt sentence as follows for a refrigerator in an abnormal state with an irritated user:
“You are an AI assistant that creates notification messages for a home appliance monitoring system.

Target appliance: refrigerator

Current abnormal condition: The refrigerator door has been left open for more than 3 minutes, and the internal temperature is 5° C. above the set value.

User's emotional state: irritation (medium to high level); the user has received the same warning 3 times in the last 5 minutes.

Requirement: Please create one very short Japanese voice message sentence that only states (1) what is happening and (2) what the user should do now, in a way that does not increase the user's stress.”

For a drum-type washing machine with an error and a confused elderly user, the server may generate:
“You are an AI assistant that supports a household washing machine.

Target appliance: drum-type washing machine

Current abnormal condition: Error code indicating drainage failure.

User's emotional state: confusion and anxiety are estimated to be high. The user may be an elderly person.

Requirement: Please create a polite and easy-to-understand Japanese explanation in honorific style for an elderly user.

The explanation must include (1) a description of what is happening now, (2) the first action to take for safety, (3) up to three simple check steps that the user can perform by themselves, and (4) guidance on how to contact support if they do not understand.”

For an energy-saving advisory scenario, the server may generate:
“You are an energy-saving advisor for a household refrigerator.

Target appliance: refrigerator

Current condition: The internal temperature is normal, but the power consumption during the last week is 20% higher than average.

User's emotional state: the user is estimated to be calm and highly motivated to learn.

Requirement: Please output five concrete pieces of advice in Japanese, in bullet points, that lead to energy savings for the refrigerator, including somewhat technical content.

Each piece of advice should be one or two sentences and briefly explain why it contributes to energy saving.”

The server thus uses a non-conventional, structure-aware prompt generation mechanism that explicitly encodes operating states, emotional states, and output constraints into the prompt sentence. This structured prompt sentence causes the generative AI model to produce outputs that are adapted to both the appliance and the user, which constitutes an improvement over generic prompts that do not utilize such detailed context.

### D.2 Generative AI Model Invocation

The server sends the prompt sentence to a generative AI model. The generative AI model may be a large language model having a transformer architecture with multiple layers of self-attention and feedforward networks, trained on a large-scale text corpus. The generative AI model receives the prompt sentence as input and outputs a sequence of tokens representing the notification message.

The server performs the following operations:
The server tokenizes the prompt sentence using a tokenizer compatible with the generative AI model, mapping text to integer token identifiers.
The server forwards the token sequence to the generative AI model, specifying generation parameters such as maximum output length and temperature.
The generative AI model processes the input through a plurality of layers. Each layer performs attention computations and nonlinear transformations. The model maintains internal state vectors representing the prompt context.
The model outputs, at each generation step, probability distributions over possible next tokens. The server selects tokens by sampling or selecting the highest probability tokens, subject to constraints such as prohibited tokens or stop sequences.

The server obtains a candidate notification message, converted back to text. The server evaluates the result against certain criteria, such as maximum length and presence of disallowed words. If necessary, the server truncates or modifies the message using post-processing functions.

By integrating explicit operating state and emotional state information into the prompt sentence, and by controlling generation parameters, the server guides the generative AI model into a constrained region of its output space that is tailored to the current context. This reduces the need for extensive rule-based post-processing and improves computational efficiency and output quality.

### E. Audio Signal Generation and Output

The server converts the notification message into an audio signal. The server submits the notification text and desired prosody parameters, derived from the emotional state, to a speech synthesis engine. The speech synthesis engine may be a neural TTS model that uses an encoder-decoder structure to map text to acoustic features and then to a waveform.

The server:
Selects a voice profile corresponding to, for example, a calm and clear voice.
Sets parameters such as speaking rate, pitch, and volume according to the emotional state; for example, a slower and softer voice for an anxious user, or a concise and neutral tone for an irritated user.
Requests generation of an audio waveform from the TTS engine.
Encodes the waveform into an audio file.

The server then transmits the audio file or a stream of audio frames to the terminal via the communication network. The terminal receives the audio signal, decodes it if necessary, and drives the speaker to output audible sound to the user.

This process constitutes more than simple conversion of text to speech. The processor dynamically adjusts audio characteristics based on the emotional state and the appliance state, which results in a technical effect: improved intelligibility under noisy conditions, reduced repeat notifications due to better comprehension, and lower network and processing load because fewer re-notifications and follow-up messages are required.

### F. Technical Effects and Computer Technology Improvements

The server improves computer technology in several ways.

First, the server reduces processing redundancy by tightly coupling operating state detection and emotion estimation with prompt sentence generation. In conventional systems, emotion estimation, if present, is disconnected from message generation and requires manual configuration of templates. In this system, the server automatically encodes both states into structured prompt sentences, which reduces the number of hard-coded templates and allows the generative AI model to produce diverse yet constrained messages. This reduces development effort and improves maintainability of the software.

Second, the server improves data management and computation efficiency by using well-defined data structures for logs and states. The server avoids redundant data conversions and leverages vectorized operations for model inference. The integration of anomaly detection and emotion estimation within the same infrastructure optimizes memory usage and reduces input/output operations.

Third, the server improves precision and robustness of notifications. By combining multiple models (time-series models, autoencoders, emotion estimators) and integrating their outputs, the server reduces false positives and false negatives in both appliance anomaly detection and emotion recognition. This leads to fewer unnecessary notifications and more accurate advice. In computational terms, this reduces wasted processing cycles and network bandwidth. Fourth, the server uses non-conventional rules and data flows that differ from human work. A human operator might manually read logs and decide on messages, but cannot feasibly process high-frequency time-series data and multimodal emotional indicators in real time. The server, by contrast, executes numerical optimization algorithms, backpropagation, and gradient descent during training, and later performs high-speed inference operations on vectorized representations. The server's prompt generation is based on explicit numerical thresholds (for example, emotion intensity and anomaly scores) and rule sets that translate internal computational states into prompt fields, rather than simply automating human-written scripts.

Fifth, the server reduces communication load by making initial notifications more effective. If the first message is appropriately tailored, the user is less likely to request repeated explanations. Therefore, the number of round trips between the terminal and the server is reduced. This leads to reduced network resource consumption and shorter end-to-end latency. Sixth, by closing the loop with user responses, the server further refines its models and prompts over time. The server can adjust weights in fusion models or adjust thresholds based on observed behavior, thereby continually improving technical performance.

### G. Alternative Embodiments and Variations

In another embodiment, the server uses different model architectures. For example, the server may replace the LSTM-based temperature prediction model with a temporal convolutional network or a transformer-based time-series model. The server may also use a variational autoencoder for anomaly detection to capture uncertainty.

In another embodiment, the server executes the generative AI model locally instead of via a network API. In such a case, the server stores model parameters in the storage and executes inference on a hardware accelerator. This reduces reliance on external services and further decreases network latency.

In another embodiment, the terminal performs part of the analysis, such as simple anomaly detection or pre-filtering of voice data, to reduce the amount of data transmitted to the server. The terminal can compress audio data or summarize operation logs before transmission, which reduces communication bandwidth.

In another embodiment, the server uses a rule-based fallback mechanism if the generative AI model is unavailable or produces an output that does not meet constraints. The server then switches to a simplified template-based message generation process while still leveraging operating state data and emotional state data.

In still another embodiment, the system is applied to industrial equipment, medical devices, or mobility devices instead of household appliances, while maintaining the same technical structure of logging, analysis, emotion estimation, prompt generation, generative AI invocation, and audio synthesis.

Through these embodiments, the server and the terminal cooperate to realize an integrated system that does not merely automate human notification tasks but improves the underlying computing mechanisms for data acquisition, state estimation, prompt construction, content generation, and audio synthesis. The system thereby achieves improved processing speed, increased accuracy, reduced error rates, and optimized communication and resource usage compared to conventional systems.

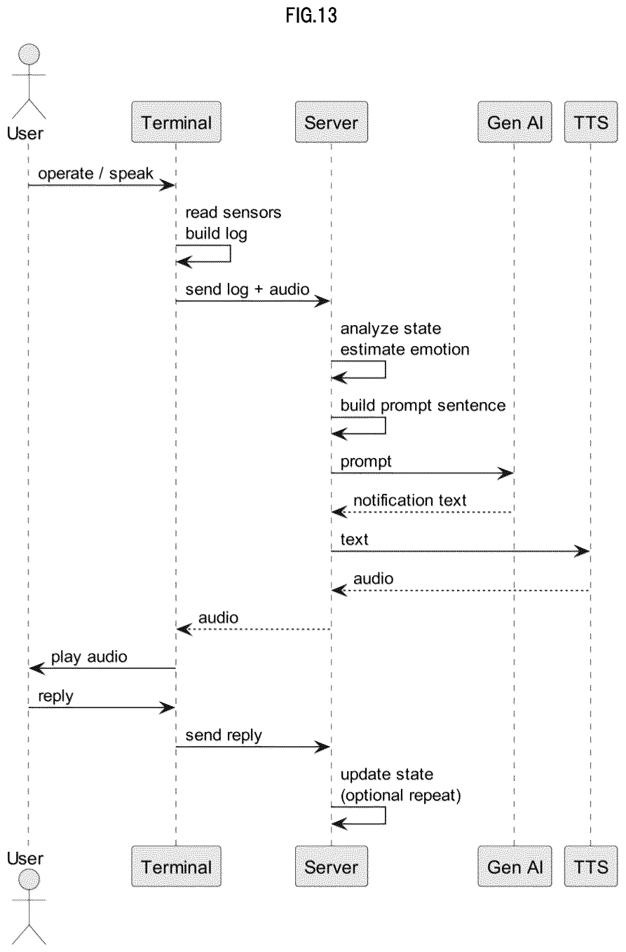

The following describes the processing flow using FIG. 13.

### Step 1:

The terminal acquires raw sensor signals from the appliance.

The terminal receives, as input, analog or digital signals from a temperature sensor, a vibration sensor, a power sensor, and an acoustic sensor via interfaces such as an I²C bus, an SPI bus, and analog input lines. The terminal samples these signals at predetermined intervals using an analog-to-digital converter and hardware timers under control of an embedded operating system. The terminal performs data processing by executing numeric routines that convert the sampled values into engineering units (for example, degrees, acceleration, watts) and apply moving average and low-pass filters to reduce noise. The terminal outputs, as a result, time-series sensor measurement values each associated with a timestamp.

### Step 2:

The terminal records user operation events and voice data.

The terminal receives, as input, button press signals from general-purpose input/output pins, touch events from a touch controller, and acoustic signals from a microphone. The terminal detects each button press and touch coordinate via device drivers and assigns an event type, a target function, and an occurrence time. For voice input, the terminal samples the microphone signal at a fixed sampling rate and buffers pulse-code modulated samples into memory until a recording condition is met. The terminal performs data processing by packaging the events into structured operation history entries and by writing buffered audio samples to a file in a standardized audio format. The terminal outputs user operation history data and associated voice data identifiers.

### Step 3:

The terminal constructs operation log data.

The terminal receives, as input, sensor measurement values from Step 1, operation history data and voice data identifiers from Step 2, and current time information from a real-time clock. The terminal performs data processing by aggregating the sensor values over a time window to compute metrics such as average temperature, maximum temperature, total power consumption, and by listing error codes and warning events that occurred. The terminal composes a record including appliance identification, user identification, time range, aggregated metrics, raw time-series snippets if needed, operation event lists, environment conditions, and links to voice data. The terminal serializes this record into a structured text representation. The terminal outputs a complete operation log entry ready for transmission.

### Step 4:

The terminal transmits the operation log entry and voice data to the server.

The terminal receives, as input, the operation log entry from Step 3 and corresponding audio files stored in local storage. The terminal performs data processing by formatting the log entry as a request payload, establishing a secure communication session over a communication network, and attaching the audio files either as multipart binary data or as pre-uploaded file references. The terminal sends an HTTP request containing the payload to a designated server address and waits for a response code. The terminal outputs network packets that encapsulate the log entry and the voice data for reception by the server.

### Step 5:

The server receives and stores the operation log entry and voice data.

The server receives, as input, the network packets transmitted by the terminal in Step 4 via a communication interface and a web service endpoint. The server performs data processing by reconstructing the request, parsing the structured text of the log entry into internal data structures, and validating required fields. The server writes the parsed log fields into records in a database and stores the received audio files in persistent storage, linking each file to the corresponding log record by an identifier. The server outputs stored log data and stored voice data that can be retrieved for later analysis.

### Step 6:

The server analyzes the stored operation log data to determine an operating state of the appliance.

The server receives, as input, the stored log data from Step 5, including temperature sequences, vibration sequences, power measurements, sound measurements, error codes, and time information. The server performs data processing by first normalizing time-series values using precomputed means and standard deviations, then feeding the normalized sequences into one or more trained machine learning models such as sequence prediction models, reconstruction models, and classifiers. The server calculates prediction errors or reconstruction errors for each sequence and compares these errors against predetermined thresholds to classify behavior as normal or abnormal. For categorical signals like error codes, the server uses rule-based mappings or classification models to refine the abnormality type. The server aggregates these analysis results into an operating state representation that includes at least a state label, an abnormality type, and urgency information. The server outputs operating state data associated with the appliance and the time period.

### Step 7:

The server estimates an emotional state of the user based on voice data and operation history data.

The server receives, as input, the stored voice data and associated operation history data from Step 5, together with environment information linked to the log entry. The server performs data processing by running speech recognition on the voice data to obtain transcribed text and by extracting acoustic features such as pitch, energy, and speaking rate from the waveform. The server feeds the transcribed text into a text emotion classifier to compute probabilities for emotion categories and polarities. The server feeds the acoustic features into a speech emotion model to obtain emotion intensity scores. The server also computes behavioral indicators from the operation history, such as counts of repeated operations and error resets, and combines these with environment variables in a stress estimation model to obtain a stress level. The server fuses these model outputs by applying a weighting or a meta-model to derive a single emotional state description. The server outputs emotional state data, including emotion labels and intensities.

### Step 8:

The server generates a prompt sentence for a generative AI model based on the operating state and the emotional state.

The server receives, as input, the operating state data from Step 6 and the emotional state data from Step 7, and may also reference user profile information stored in the database. The server performs data processing by selecting a prompt template that matches the appliance type and notification purpose, then inserting the operating state description, the emotional state description, and constraints on output style, detail level, tone, and structure into the template. The server concatenates fixed text phrases and dynamically generated content into a coherent text string that instructs a generative AI model how to compose a notification message. The server outputs a fully constructed prompt sentence describing the context, the user's emotional state, and the requirements for the notification.

### Step 9:

The server obtains a notification message from the generative AI model using the prompt sentence.

The server receives, as input, the prompt sentence from Step 8. The server performs data processing by encoding the prompt sentence into token sequences according to the vocabulary of the generative AI model and transmitting those sequences to the model through an inference interface. The server specifies generation parameters, such as maximum token count and sampling strategy, that bound the output. The generative AI model processes the token sequence internally and returns a sequence of output tokens representing the generated notification. The server decodes the tokens back into human-readable text and performs validation checks, such as length restrictions and forbidden phrase screening. If required, the server trims or lightly edits the result. The server outputs a notification message text that reflects the appliance state and the user's emotional state.

### Step 10:

The server converts the notification message into an audio signal.

The server receives, as input, the notification message text from Step 9 and the emotional state data from Step 7. The server performs data processing by determining suitable synthesis parameters, such as speaking rate, pitch, volume, and voice type, based on the user's emotion and the urgency of the situation. The server sends the notification text and the synthesis parameters to a speech synthesis engine, which generates a digital audio waveform. The server may further encode the waveform into a compressed audio format. The server outputs an audio signal file or a stream that can be reproduced by the terminal's audio output device.

### Step 11:

The server transmits the audio signal to the terminal for playback.

The server receives, as input, the audio signal from Step 10 and information identifying the destination terminal and appliance. The server performs data processing by packaging the audio signal or its location reference into a response payload together with metadata such as notification type and playback priority. The server sends this payload to the terminal via the established communication channel. The server outputs network packets carrying the audio notification data toward the terminal.

### Step 12:

The terminal receives the audio notification data and outputs the corresponding sound to the user.

The terminal receives, as input, the network packets from Step 11 through its communication module. The terminal performs data processing by reconstructing the payload, retrieving or downloading the audio file if a reference was provided, and preparing the audio for playback. The terminal configures the audio playback module with parameters such as volume level, possibly considering current appliance noise levels. The terminal feeds the audio data to the digital-to-analog converter connected to the speaker. The terminal outputs audible sound that communicates the notification message to the user.

### Step 13:

The user listens to the notification and provides a response.

The user receives, as input, the audible notification message from Step 12. The user performs cognitive processing to understand the content and decides on a reaction. The user may respond by taking a physical action on the appliance, by pressing a control on the terminal, or by speaking a short phrase such as a confirmation, a denial, or a request for more detail. The user outputs either operation events via the terminal's input interface or voice data via the microphone.

### Step 14:

The terminal captures the user's response and forwards it to the server.

The terminal receives, as input, the user's operation events or voice signals from Step 13. The terminal performs data processing by logging new operation events with timestamps and recording a segment of audio that captures the spoken response. The terminal associates these data with the identifier of the original notification so that the server can correlate them. The terminal packages the operation history updates and the new voice data into a response payload and sends it to the server via the communication module. The terminal outputs network packets containing user response data.

### Step 15:

The server updates its state based on the user's response and, if necessary, repeats the notification cycle.

The server receives, as input, the user response data from Step 14. The server performs data processing by re-running speech recognition and emotion estimation on the newly received voice data, updating the emotional state, and interpreting the semantics of the response from the recognized text and operation history. Depending on the interpreted content, the server may update the operating state of the appliance, issue control commands back to the terminal, or decide to provide additional explanations. If further guidance is needed, the server generates a new prompt sentence that reflects the updated operating state and emotional state, and then repeats the steps of obtaining a notification message, generating an audio signal, and transmitting it to the terminal. The server outputs updated operating state data, updated emotional state data, and, when applicable, additional notification messages and audio signals.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In care and monitoring environments, conventional computer-implemented monitoring systems primarily focus on physical state analysis based on single-modal sensor streams, such as temperature or power consumption, and employ simple threshold-based alerting. Such systems typically do not integrate multimodal information, such as biological signals, behavioral patterns, acoustic signals, and image signals, in a unified computational workflow, and therefore cannot accurately reflect complex real-world conditions such as the combination of physiological abnormalities and emotional states. As a result, the processor frequently generates excessive false alarms, fails to prioritize notifications according to real urgency, and imposes a high cognitive load on operators.

In addition, in many existing systems, the logic for determining abnormalities and generating alerts is manually designed and static. Once deployed, the underlying machine learning models or rule sets for health state analysis and emotion analysis are rarely updated based on real operational feedback. This lack of closed-loop learning prevents continuous improvement of model performance and limits the adaptability of the system to the specific environment, user population, and device configuration. Consequently, the computer system is not efficiently utilizing available computational resources and data feedback, and its predictive accuracy and relevance degrade over time.

Furthermore, conventional notification subsystems rely on fixed templates or simple parameterized text to generate messages, without leveraging advanced text generation capabilities. Even when large-scale generative AI models exist as external services, typical systems do not provide a structured, processor-controlled mechanism to construct precise prompt sentences from internal analysis results and do not integrate the generative AI model into the end-to-end decision pipeline. Therefore, the notification content is often poorly matched to the context, is difficult for users to interpret quickly, and does not exploit the potential of generative models to improve clarity and usefulness of alerts.

From a computer-technology standpoint, there is a need for an improved architecture in which a processor can (i) efficiently preprocess and fuse heterogeneous time-series data, (ii) perform coordinated health state and emotion analysis using machine learning models, (iii) convert integrated analysis results into structured prompt sentences for a generative AI model, and (iv) update analysis models based on operational feedback and responses obtained from the generative AI model. Without such an architecture, the overall computing pipeline remains fragmented, under-optimized, and unable to systematically improve over time.

Accordingly, one object of the present invention is to provide a computer-implemented system in which a processor coordinates multimodal data acquisition, numerical preprocessing, health state anomaly detection, emotion analysis, prompt construction for a generative AI model, and adaptive model updating, thereby improving the technical performance of the monitoring and notification functions themselves. Another object is to reduce unnecessary notifications while preserving or increasing sensitivity to critical events, and to enhance the efficiency with which the processor generates and delivers context-appropriate notification content.

The specific processing by the specific processing unit 290 of the data processing device 12 in Application Example 2 is realized by the following means.

The present invention provides a server comprising a processor configured to acquire operation information including biological information and behavioral information regarding a subject and record the operation information as time-series data, perform numerical processing and feature extraction processing on the recorded operation information to generate a feature sequence including statistical indices and frequency components, input the feature sequence to a machine learning model and determine presence or absence of an abnormality and a degree of the abnormality in a health state of the subject as a health state analysis result, acquire emotion-related information including acoustic information and image information and estimate an emotional state of the subject on a basis of the emotion-related information and the biological information and the behavioral information as an emotion analysis result, integrate the health state analysis result and the emotion analysis result to determine whether notification is required and to determine a notification priority, construct a prompt sentence for input to a generative AI model on a basis of an integration result and attribute information of the subject, transmit the constructed prompt sentence to the generative AI model, receive a response text from the generative AI model, generate character information representing notification content on a basis of the response text, convert the character information into an audio signal as a notification audio signal, transmit the notification audio signal and the character information to an output device to provide a notification to a user, transmit and receive data and analysis results used in acquiring and recording the operation information and in performing the health state analysis and the emotion analysis to and from another information processing apparatus via a communication network, and update at least one of parameters and decision criteria of the machine learning model used in the health state analysis and the machine learning model used in the emotion analysis on a basis of a response obtained from the generative AI model and feedback information obtained from the user. This enables the server to implement an improved computer-implemented processing pipeline that (i) fuses heterogeneous sensor and media streams into machine-readable feature sequences, (ii) performs coordinated abnormality detection and emotion estimation using machine learning models, (iii) programmatically constructs and issues prompt sentences to a generative AI model to obtain context-appropriate notification text, and (iv) adaptively updates model parameters and decision criteria based on operational feedback, thereby reducing false notifications, improving prioritization accuracy, and enhancing the overall technical performance and efficiency of the monitoring and notification system.

The term “system” refers to an arrangement of one or more information processing apparatuses, including at least a server comprising a processor, and optionally one or more terminal devices and sensors, that cooperate to execute the functions described in the claims. The term “server” refers to an information processing apparatus comprising at least one processor, a memory, a storage device, and a communication interface, configured to execute programs that implement acquisition, analysis, integration, prompt generation, interaction with a generative AI model, notification generation, and model updating as described in the claims.

The term “processor” refers to one or more hardware circuits, such as a central processing unit or a graphics processing unit, that execute machine-readable instructions to perform arithmetic operations, logical operations, control operations, and data transfer operations implementing the functions recited in the claims.

The term “subject” refers to an entity being monitored by the system, typically a human individual whose biological information, behavioral information, and emotional state are acquired, analyzed, and used for generating notifications.

The term “operation information” refers to information related to the state or behavior of the subject and the environment, including at least biological information and behavioral information, and optionally including acoustic information and image information, that is acquired and recorded as time-series data.

The term “biological information” refers to information indicating a physical state of the subject, including values representing at least body temperature, heart rate, respiration rate, blood pressure, or outputs from sensors configured to measure physiological parameters.

The term “behavioral information” refers to information indicating a movement or activity state of the subject, including at least a movement state, a posture state, an activity index, or an output from a sensor configured to detect motion, position, or contact.

The term “acoustic information” refers to information representing sound associated with the subject or an operator, including at least a voice waveform, audio samples, or acoustic feature sequences derived from such waveforms.

The term “image information” refers to information representing visual data associated with the subject or an operator, including at least image frames or video frames, and optionally including a face region and facial expression features extracted from the image frames.

The term “time-series data” refers to data in which each record is associated with a time index, such as a timestamp, and that represents a sequence of measurements or observations obtained over time from at least one sensor or input device.

The term “numerical processing” refers to processing operations performed by the processor on numerical data, including at least filtering, smoothing, outlier removal, interpolation, and spectral analysis performed on time-series data.

The term “feature extraction processing” refers to processing that transforms raw operation information into a feature sequence, including at least computation of statistical indices, frequency components, or other derived quantities that can be input to a machine learning model.

The term “feature sequence” refers to an ordered set of feature vectors, each feature vector including one or more numerical features representing characteristics of the operation information over a corresponding time window.

The term “statistical indices” refers to scalar or vector values computed from operation information, including at least a mean, variance, minimum, maximum, rate of change, or count of events within a defined time interval.

The term “frequency components” refers to values representing spectral characteristics of time-series data, including at least dominant frequencies, power in specific frequency bands, or other quantities obtained by frequency-domain analysis such as a Fourier transform.

The term “machine learning model” refers to a computational model whose parameters are trained on data, including at least a regression model, a classification model, a time-series prediction model, or a neural network, and that outputs a prediction or decision when provided with a feature sequence as input.

The term “health state analysis result” refers to an output generated by the machine learning model for health state analysis, including at least a determination of presence or absence of an abnormality in the health state of the subject and optionally a degree or severity of the abnormality.

The term “emotion-related information” refers to information used to estimate an emotional state of the subject, including at least acoustic information and image information, and optionally including biological information and behavioral information.

The term “emotional state” refers to a psychological or affective state of the subject estimated by the processor, including at least one of anxiety, fear, confusion, calmness, sadness, joy, or an intensity associated with such a state.

The term “emotion analysis result” refers to an output generated by a machine learning model for emotion analysis, including at least an emotion category label and an associated emotion intensity value.

The term “integration result” refers to a result obtained by the processor by combining the health state analysis result and the emotion analysis result, including at least a determination of whether notification is required and a notification priority.

The term “notification priority” refers to data indicating an urgency or importance level of a notification, including at least a discrete level designation such as high, medium, or low, or an equivalent numeric or categorical value.

The term “prompt sentence” refers to a text string constructed by the processor and provided as input to a generative AI model, the text string including at least the integration result and attribute information of the subject, and specifying conditions and requirements for the output of the generative AI model.

The term “generative AI model” refers to a machine learning model configured to generate text or other content based on an input text, including at least a large-scale language model or another generative model that can produce a response text from a prompt sentence.

The term “response text” refers to a text generated by the generative AI model in response to the prompt sentence, and received by the processor via a communication interface.

The term “character information” refers to text data constructed by the processor on the basis of the response text, the text data representing human-readable notification content to be provided to a user.

The term “notification audio signal” refers to an audio signal generated by the processor by converting character information into synthesized speech, the audio signal being suitable for playback by an audio output device.

The term “output device” refers to a device capable of presenting notification content to a user, including at least a terminal device with a display, a speaker, or another output interface that can output the notification audio signal and the character information.

The term “communication network” refers to a wired or wireless network used to transmit data between the server and another information processing apparatus or a terminal device, including at least a local area network, a wide area network, or the Internet.

The term “analysis results” refers to outputs produced by the processor in executing health state analysis, emotion analysis, and integration, including at least the health state analysis result, the emotion analysis result, and the integration result.

The term “another information processing apparatus” refers to any computing device other than the server that participates in data exchange with the server, including at least a terminal device, a gateway device, or an external service system.

The term “feedback information” refers to information obtained from a user or from a terminal device indicating a response result, an actual situation at a site, or an evaluation of a notification, and used by the processor to update machine learning models or decision criteria.

The term “parameters” refers to adjustable numerical values internal to a machine learning model, including at least weights, biases, thresholds, or other tunable quantities that influence the model's output.

The term “decision criteria” refers to rules or thresholds used by the processor to interpret outputs of machine learning models, including at least conditions for setting abnormality flags, determining notification necessity, and assigning notification priorities.

The term “health state analysis” refers to processing by the processor in which the feature sequence derived from operation information is input to a machine learning model to determine the health state analysis result.

The term “emotion analysis” refers to processing by the processor in which emotion-related information, including at least acoustic information and image information, and optionally biological information and behavioral information, is input to a machine learning model to determine the emotion analysis result.

The term “terminal device” refers to a device separate from the server, including at least a portable information terminal or a fixed display apparatus, configured to receive notification content from the server via the communication network and to present the notification content to a user.

The term “notification content” refers to information representing what is to be notified to a user, including at least character information and the notification audio signal, and optionally including associated metadata such as the notification priority and identifiers of the subject.

In the following embodiments, a server, a terminal, and a user cooperate to implement the claimed system. The embodiments are provided as examples and do not limit the scope of the claims.

Server operates as a central information processing apparatus that includes at least one processor, a main memory, a non-volatile storage device, and a communication interface.

Server executes an operating system such as a server-oriented operating system and application software implementing the acquisition, preprocessing, analysis, integration, prompt sentence generation, interaction with a generative AI model, notification generation, and model updating. Server may use software libraries including, for example, a numerical computation library (such as NumPy), a data-frame processing library (such as pandas), a statistical learning library (such as scikit-learn), a machine learning framework (such as TensorFlow or PyTorch), an audio-processing library (such as librosa), a multimedia tool (such as FFmpeg), and an image-processing library (such as OpenCV). Server may access external speech-recognition and text-to-speech services through their application programming interfaces.

Terminal operates as a portable or fixed information device used by a user. Terminal may be implemented as a smartphone, a tablet, or a workstation. Terminal executes a mobile or desktop operating system and a client application that communicates with server through a wireless or wired communication network. Terminal includes a display, a speaker, a microphone, a touch interface, and a network interface. Terminal presents notifications generated by server to the user and transmits user feedback to server.

User includes a monitored subject and an operator. The monitored subject is an individual whose biological information, behavioral information, and emotional state are acquired by sensors and processed by server. The operator is an individual who receives notifications on terminal and performs actions in response to the notifications, and who inputs feedback through terminal.

Server acquires operation information as time-series data from various sensing devices. Sensor devices include biological sensors such as temperature sensors, heart rate sensors, respiration sensors, and pressure sensors, and behavioral sensors such as motion sensors, posture sensors, and contact sensors embedded in the floor or bed. Sensor devices may be connected to a local gateway that aggregates sensor outputs and forwards time-stamped records to server using a message-oriented communication protocol such as MQTT over TCP/IP.

Server stores raw sensor messages into a relational database as time-series records with fields including a subject identifier, a sensor type code, a measured value, a timestamp, and a quality flag. Server defines specific data structures, for example a table for biological information and a table for behavioral information, each indexed by subject identifier and timestamp. By organizing operation information into normalized time-series tables, server reduces data redundancy and accelerates query processing, which improves computational efficiency when server executes later analysis.

Server performs numerical processing and feature extraction on the recorded operation information. Server loads recent time-series segments into memory as arrays and data frames using NumPy and pandas. For continuous biological information such as body temperature and heart rate, server applies smoothing filters such as moving average filters and median filters to reduce noise. Server uses outlier detection by computing rolling means and standard deviations and discarding or clipping measurements that lie beyond a configurable number of standard deviations. These specific numerical operations reduce sensor noise and measurement artifacts and improve the stability of downstream machine learning inference, thereby improving accuracy and reducing false positives.

Server performs frequency analysis on high-resolution behavioral information such as floor pressure or bed pressure signals. Server uses NumPy's fast Fourier transform functions to convert time-domain signals into frequency-domain representations. Server then identifies dominant frequency components and peak power within specified bands and maps them to estimated respiration rates or periodic activity patterns. This computational technique allows server to derive latent physiological indicators from non-contact sensors, which a human operator cannot reliably infer in real time, and thus constitutes an improvement in the way the computer processes heterogeneous sensor streams to produce machine-usable features.

Server constructs feature vectors by combining multiple derived quantities such as mean, variance, minimum, maximum, slope, event counts, and dominant frequencies over sliding time windows. Server defines a fixed ordering of feature elements and stores each feature vector as a row in a feature table, with columns corresponding to each derived quantity and a window identifier. Server assembles feature vectors into feature sequences, which are passed to machine learning models as multi-dimensional tensors. By standardizing the feature sequence structure, server reduces memory fragmentation and can exploit vectorized computation on the processor or an attached accelerator, improving processing throughput. Server performs health state analysis using one or more machine learning models implemented in TensorFlow or PyTorch. In one embodiment, server uses a recurrent neural network such as a long short-term memory network with multiple layers. The network architecture may include an input layer whose dimension equals the feature dimension, one or more LSTM layers with a specified number of hidden units, and a fully connected output layer producing one or more scores representing probabilities of different health abnormalities, such as fever, respiratory abnormality, or fall risk. Server stores model parameters, including weight matrices and bias vectors, in persistent storage and loads them into main memory at startup.

Server trains the health state model prior to deployment by using supervised learning on historical labeled time-series data. Server defines a loss function such as cross-entropy loss for classification of abnormality categories and uses an optimization algorithm such as stochastic gradient descent, Adam, or RMSProp to update model parameters. Server may use data augmentation techniques such as time warping, noise injection, or resampling to increase the robustness of the model against sensor noise and missing data. By executing these specific training procedures, server configures a model that accurately maps feature sequences to health state analysis results.

Server performs emotion analysis using another machine learning model. Server receives acoustic information from terminal or from microphones connected to the network. Server uses librosa to extract audio features such as pitch contour, energy, spectral centroid, and mel-frequency cepstral coefficients from the audio waveform. Server may normalize these features by z-score normalization over a sliding window. Server calls an external speech-recognition service through its API to obtain a text transcript of spoken content. Server represents the text as a numerical vector by applying, for example, a word-embedding technique or a transformer-based encoding.

Server may also process image information captured by cameras. Server uses OpenCV to detect a face region in each frame and to extract facial landmarks. Server derives facial expression features such as distances and angles between landmarks and texture descriptors in regions of interest. These features are combined with audio features and text features into a unified feature vector for emotion analysis.

Server implements the emotion analysis model using a neural network architecture that may include a convolutional neural network for image features, a recurrent network or transformer encoder for audio and text sequences, and a fully connected fusion layer that outputs emotion category scores. Server trains this model on multimodal datasets labeled with emotion categories and intensities, using a loss function such as categorical cross-entropy and optimization techniques similar to those used in the health state model. By fusing heterogeneous modalities in a learned manner, server achieves higher accuracy and robustness in emotion estimation than simple rule-based heuristics, which constitutes a technical improvement in pattern recognition on multimodal time-series data.

Server integrates the health state analysis result and the emotion analysis result by executing an integration module. In one embodiment, server implements the integration module as a rule-based engine that evaluates predefined conditions on abnormality flags, severity indices, emotion labels, and emotion intensities. For example, server may define a rule that assigns a high notification priority when both a fever probability exceeds a threshold and an anxiety intensity exceeds another threshold. In another embodiment, server implements the integration module as a classifier model that takes as input a vector containing numeric encodings of health and emotion results and outputs a notification necessity flag and a notification priority score. Server may use a decision tree, a random forest, or a neural network for this purpose. The specific integration of multiple analysis outputs into a single decision allows server to reduce redundant alerts and to focus limited processing and communication resources on significant events.

Server constructs a prompt sentence for a generative AI model based on the integration result and attribute information of the subject. Server uses a template-based text construction module that receives structured fields such as subject name, age, health abnormalities, emotion label, emotion intensity, and notification priority, and inserts them into a predefined natural language template. As an example, server may generate the following prompt sentence for an alert message:
“You are an alert message generation system for care facilities.

Based on the following conditions, create a Japanese voice notification message to be sent to caregiving staff.
User name: Mr./Ms. A
Age: 82
Health condition: Body temperature increased to 38.2° C., heart rate 15% higher than normal
Emotional state: Strong anxiety detected
Desired message tone: Calm, but clearly conveying urgency

Please include specific instructions in two to three sentences so that caregiving staff can take immediate action.”

As another example, server may generate the following prompt sentence for care procedure suggestion:
“You are a care support assistant for a care facility.

For the following situation, present the response procedures that caregiving staff should take in a bullet-point format.
User name: Mr./Ms. B
Age: 79, with mild dementia
Situation: Since 2:00 a.m., there has been an increase in wandering behavior within the room, and the emotion engine estimates a ‘confused’ state
Multiple abnormal pressure events have also been detected by the fall sensor Please also write two examples of specific verbal prompts that caregiving staff can use to both ensure safety and provide reassurance.”

As a further example, server may generate the following prompt sentence to obtain conversational examples:
“As an expert in elderly care, you will propose examples of daily conversation. For a user meeting the following conditions, create five patterns of Japanese verbal prompts intended to help improve their mood.
User name: Mr./Ms. C
Age: 85
Over the past two weeks, the emotion engine has continuously detected a ‘depressive’ state
There are no particular acute abnormalities in the health condition

Each verbal prompt should be one to two sentences long, avoid negative expressions, and provide a sense of reassurance and approval.”

Server transmits the constructed prompt sentence to a generative AI model through an HTTP-based API. Server specifies decoding parameters such as maximum length, temperature, and output format. Server receives the response text returned by the generative AI model, which typically contains a proposed alert message, procedure list, or set of phrases. Server parses the response text and performs post-processing operations such as removing unwanted sections, ensuring consistent terminology, and enforcing maximum length constraints. By programmatically constructing prompt sentences from structured internal data and systematically post-processing responses, server achieves reproducible and controlled use of a generative AI model, rather than ad hoc human interaction, and thereby improves the technical operation of the text generation pipeline.

Server generates character information for notification by selecting an appropriate part of the response text and storing it as notification text in the database. Server then calls a text-to-speech engine, either as an external API or as local software, to convert the notification text into an audio waveform. Server passes parameters such as language, voice type, speech rate, and volume to the text-to-speech engine. Server saves the generated audio file in storage and records an access identifier or URL in the corresponding notification record. This explicit conversion and storage procedure allows server to decouple notification generation from notification delivery and enables caching and re-use of repeated notification patterns, reducing computational load and network usage.

Terminal receives notification records from server through push-notification infrastructures or persistent connections. Terminal presents notification content to the operator using both visual and audio outputs. Terminal retrieves the audio file through secure communication and plays it using built-in audio playback functions. Terminal displays the notification text and supporting details on the screen. By presenting multimodal notifications, terminal allows the operator to quickly understand complex information even in noisy or visually busy environments.

User who is an operator reads the notification on terminal, listens to the audio, and performs real-world actions such as visiting the subject, measuring vital signs, and speaking with the subject. User then inputs feedback into terminal, including structured fields such as outcome status, re-measured values, and qualitative comments. Terminal packages the feedback into a structured message with fields such as event identifier, subject identifier, outcome code, and free text, and transmits the feedback to server.

Server receives feedback information and stores it in a feedback table in the database. Server periodically analyzes the feedback in combination with historical health state analysis results, emotion analysis results, and notification decisions. Server computes performance metrics such as true positives, false positives, true negatives, and false negatives for different conditions. Server may construct additional prompt sentences describing problematic patterns and ask the generative AI model for suggestions on how to adjust decision criteria, feature design, or thresholds. Server then encodes selected suggestions into updated configuration files or model architectures.

Server may retrain or fine-tune machine learning models by using newly labeled data derived from feedback. Server may adjust loss functions, for example by applying class weighting or focal loss to reduce the impact of frequent but low-priority events and emphasize rare but critical events. Server may perform hyperparameter tuning for learning rates, number of layers, and number of hidden units. By performing such closed-loop learning and dynamic threshold adjustment, server continually improves the accuracy and stability of its analysis and decision-making modules. This continuous adaptation, based on data-driven feedback and systematic interaction with a generative AI model, constitutes more than mere automation of human judgment; it improves the internal operation and performance of the computer system itself, leading to reduced processing overhead for irrelevant events and increased precision in resource allocation.

Server thereby achieves several technical effects. First, by using structured feature sequences and optimized neural network architectures, server increases inference speed and reduces computational complexity compared to naive per-sensor threshold checks. Second, by integrating multimodal analysis results and dynamically adapting thresholds and parameters, server reduces the number of false alarms and improves detection of critical events, which enhances reliability and reduces network and storage consumption associated with unnecessary alerts. Third, by controlling the generative AI model through precise prompt sentences and post-processing, server produces concise and context-appropriate notifications that are easier to parse by the operator, thus decreasing the time spent per event and indirectly reducing processing and communication overhead. These technical improvements arise from specific data structures, algorithmic flows, and model adaptation mechanisms described above, and are not limited to business or workflow automation.

In alternative embodiments, server may employ different neural network architectures, such as transformer-based time-series models instead of LSTM networks for health state analysis, or may use graph neural networks to incorporate spatial relationships between sensors. Server may also replace or supplement rule-based integration with probabilistic graphical models. Server may deploy the generative AI model locally on specialized hardware, such as a GPU-equipped node, to reduce latency and reliance on external services. Terminal may be implemented as a head-mounted display or a hands-free audio device. These variations still fall within the scope of the claims so long as server constructs prompt sentences from integrated analysis results, interacts with a generative AI model, and updates analysis models and decision criteria based on responses and feedback to improve technical performance of the monitoring and notification system.

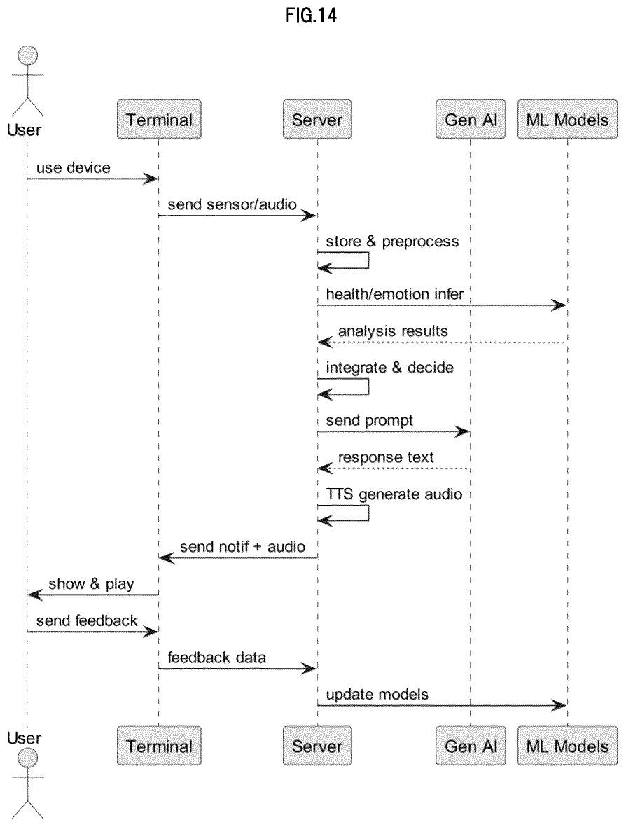

The following describes the processing flow using FIG. 14.

### Step 1:

Server receives raw operation information from sensors.

Server takes, as input, sensor messages transmitted from gateway devices, each message including at least a subject identifier, a sensor type, a measured value, and a timestamp. Server uses a communication library over a network protocol (for example, MQTT over TCP/IP) to subscribe to topics and to receive the messages in real time. Server parses each message, validates data types and value ranges, converts units if necessary, and then writes normalized records into a time-series database table. Server outputs a set of normalized time-series records stored in the database, each record being keyed by subject identifier, sensor type, and timestamp.

### Step 2:

Server performs numerical preprocessing of biological and behavioral information. Server takes, as input, the normalized time-series records from the database for a specified analysis window (for example, the last 30 minutes or 1 hour) for each subject. Server loads these records into memory as arrays or data frames using numerical libraries. Server applies smoothing operations, such as moving average and median filtering, to continuous biological signals (e.g., body temperature and heart rate) and performs outlier detection by computing rolling statistics and removing or clipping extreme values. Server outputs cleaned and smoothed time-series data for each sensor type, with noise-reduced values stored in an intermediate data structure.

### Step 3:

Server extracts statistical and frequency-domain features.

Server takes, as input, the cleaned time-series data for biological and behavioral signals.

Server computes statistical indices, such as mean, variance, minimum, maximum, slope, and event count, for each signal over fixed-length windows. For high-resolution behavioral signals such as floor pressure or bed pressure, server performs a fast Fourier transform to obtain a frequency spectrum and then identifies dominant frequency components and power in specific bands. Server combines these derived quantities into feature vectors with a fixed ordering and outputs a feature sequence (a sequence of feature vectors) for each subject and time window, stored in a feature table or passed directly to analysis modules.

### Step 4:

Server performs health state analysis using a machine learning model.

Server takes, as input, the feature sequence generated in Step 3 for each subject. Server formats the feature sequence into tensors compatible with a machine learning framework, such as TensorFlow or PyTorch, and loads a pre-trained health state model, for example a recurrent neural network with one or more LSTM layers and a fully connected output layer. Server executes forward inference on the model, computing abnormality scores such as fever probability, respiratory abnormality probability, and fall-risk probability. Server compares each score with corresponding thresholds and sets abnormality flags and severity values. Server outputs a health state analysis result for each subject, including abnormality flags, probabilities, and severity indices, and stores this result in a health state table.

### Step 5:

Server performs emotion analysis from acoustic and image information.

Server takes, as input, acoustic information (audio recordings or streams) and optionally image information (video frames or still images) associated with each subject, together with relevant biological and behavioral information. Server uses an audio-processing library to read the audio waveform, extract features such as pitch contour, energy, and mel-frequency cepstral coefficients, and normalize these features over time. Server calls an external speech-recognition API to obtain a text transcript and encodes this text numerically (for example, using an embedding layer). If image information is available, server uses an image-processing library to detect a face region, compute facial landmarks, and derive facial expression features. Server concatenates or otherwise fuses audio features, text features, and facial features and inputs them to an emotion analysis model, such as a neural network that outputs emotion category scores and intensities. Server selects the highest-scoring emotion label and corresponding intensity, and outputs an emotion analysis result for each subject, storing this result in an emotion state table.

### Step 6:

Server integrates health state analysis and emotion analysis results.

Server takes, as input, the health state analysis results from Step 4 and the emotion analysis results from Step 5 for matching or proximate timestamps for each subject. Server aligns the records and constructs an integrated input structure containing abnormality flags, severity indices, emotion labels, and emotion intensities. Server applies an integration algorithm, which may be a rule-based engine or a classifier model, to determine whether a notification is required and to compute a notification priority. For example, server may assign a high priority when both a critical abnormality flag is true and the emotion intensity exceeds a threshold. Server outputs an integration result for each candidate event, including notification necessity, notification priority, and a summary of inferred risks, and writes this integration result into an event table.

### Step 7:

Server constructs a prompt sentence for a generative AI model.

Server takes, as input, the integration result from Step 6 and attribute information of the subject, such as name, age, known conditions, and historical event patterns. Server populates a prompt template by inserting concrete values representing health state, emotional state, and desired tone and length of the output. Server concatenates the template elements into a coherent natural-language prompt sentence. Server outputs a fully constructed prompt sentence that describes the current situation and specifies requirements for the generative AI model's response.

### Step 8:

Server queries the generative AI model and generates notification text.

Server takes, as input, the prompt sentence from Step 7. Server sends the prompt sentence to a generative AI model via an HTTP-based API, specifying parameters such as maximum output length and sampling temperature. Server receives, as output, a response text containing one or more candidate messages or instructions. Server parses the response text, selects relevant sections, enforces formatting rules, and normalizes expressions to create consistent notification content. Server outputs final notification text (character information) for each event and stores it with a reference to the associated subject and integration result.

### Step 9:

Server generates a notification audio signal from the notification text.

Server takes, as input, the final notification text from Step 8. Server calls a text-to-speech engine, passing the text along with synthesis parameters such as language, voice type, and speaking rate. Server receives a synthesized audio waveform from the text-to-speech engine. Server writes the audio waveform to a file or media object in storage and generates an identifier or URL that points to the stored audio. Server outputs a notification audio signal identifier and associates it with the corresponding notification text in a notification record.

### Step 10:

Server transmits notification records to terminal.

Server takes, as input, the notification records that include notification text, notification priority, subject identifiers, and audio signal identifiers from Step 9. Server packages these items into a notification payload and uses a push-notification service or a persistent network connection to send the payload to one or more terminals associated with responsible users. Server may adjust the payload format or destination list based on notification priority and subject assignment. Server outputs transmitted notification messages on the network for subsequent handling by terminal.

### Step 11:

Terminal receives notifications and presents them to user.

Terminal takes, as input, the notification payload sent by server in Step 10. Terminal parses the payload to extract the notification text, notification priority, subject information, and audio identifier or URL. Terminal evaluates the notification priority and selects a presentation mode, such as full-screen alert with vibration for high-priority events or banner notification for lower-priority events. Terminal requests the audio file from server or a media server using the provided identifier and buffers the received audio data. Terminal outputs the notification visually by displaying the text on the display and outputs the notification aurally by playing the audio through the speaker.

### Step 12:

User performs actions and submits feedback through terminal.

User takes, as input, the visual and audio notification presented by terminal in Step 11. User visits the subject, observes the real-world condition, and may measure vital signs or interact with the subject. Based on these observations, user operates terminal to open a feedback screen linked to the notification. User enters structured feedback, such as whether a suspected event occurred, the results of any additional measurements, and qualitative comments. Terminal takes, as input, the user-entered data, packages it into a feedback message including event identifiers and timestamps, and transmits the feedback message to server. Terminal outputs a confirmation to user that the feedback has been sent.

### Step 13:

Server updates analysis models and decision criteria using feedback and generative AI responses.

Server takes, as input, the feedback messages from Step 12, together with historical health state results, emotion analysis results, integration results, and generative AI responses. Server aggregates these data into training or evaluation datasets and computes performance metrics such as error rates and confusion matrices for different conditions. Server may construct additional prompt sentences that describe problematic patterns and send them to the generative AI model to obtain suggestions on feature design or threshold adjustments. Server then updates model parameters through retraining or fine-tuning using machine learning frameworks and revises decision criteria stored in configuration files. Server outputs updated machine learning models and rules, which are loaded into memory for subsequent executions of Steps 4, 5, and 6, thereby refining health state analysis, emotion analysis, and notification decision-making over time.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

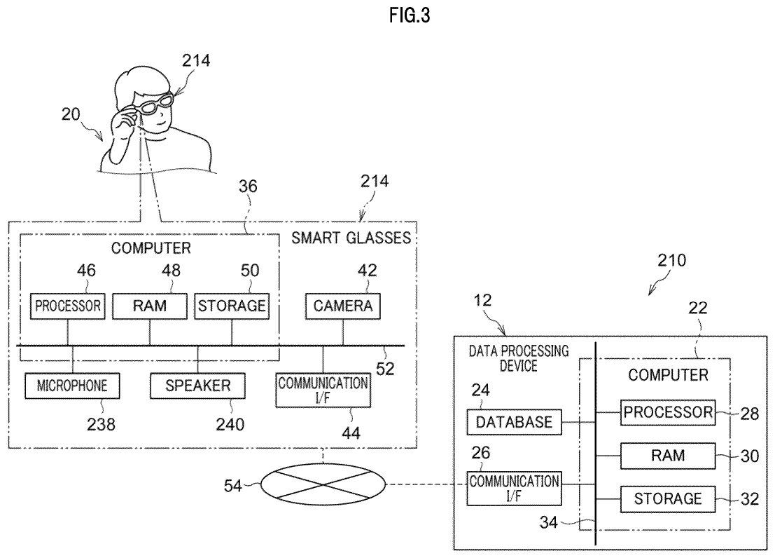

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

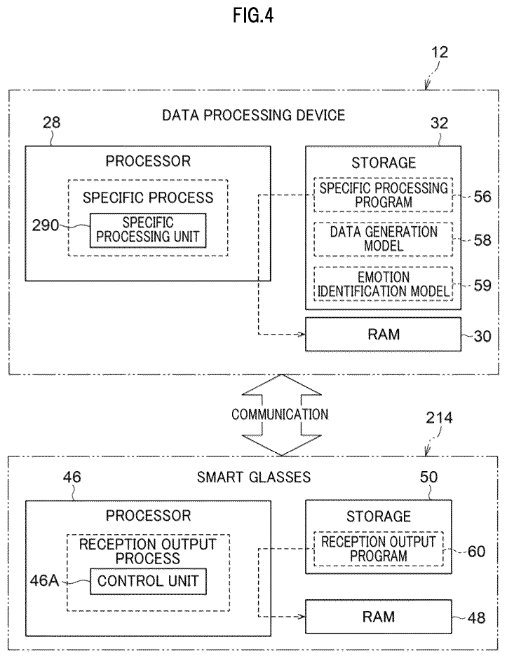

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

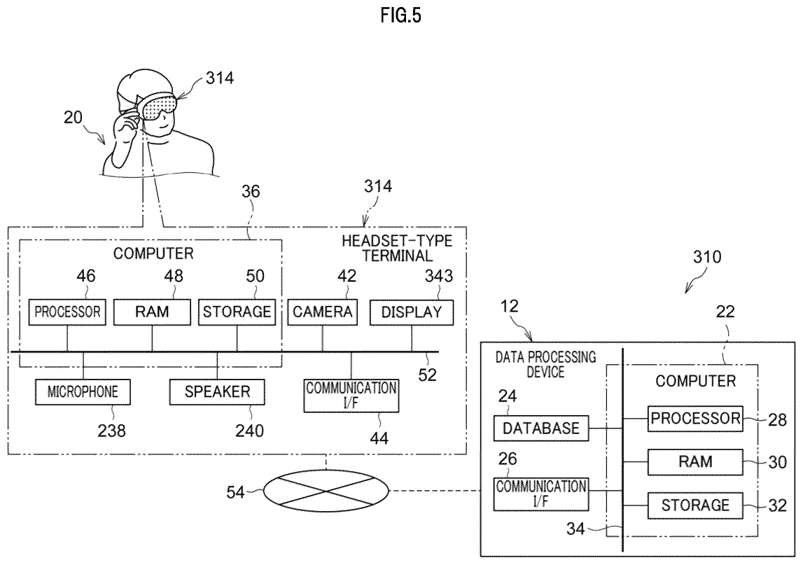

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

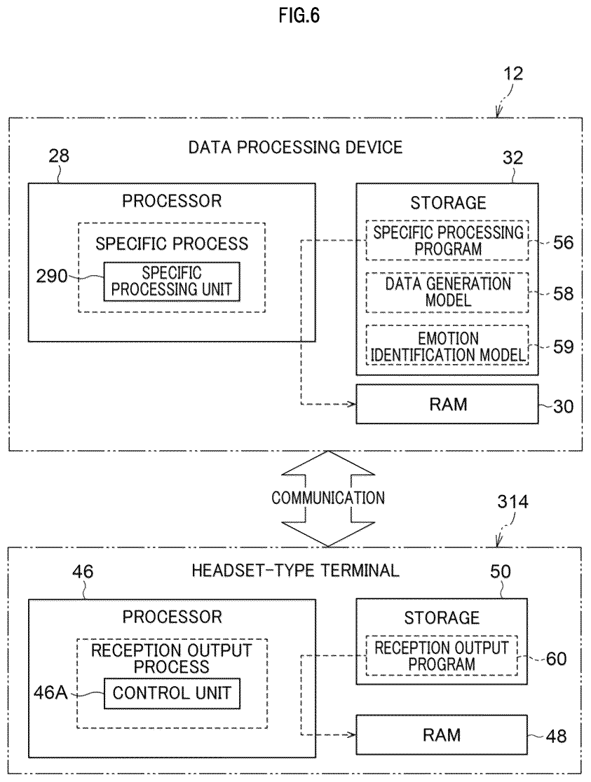

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

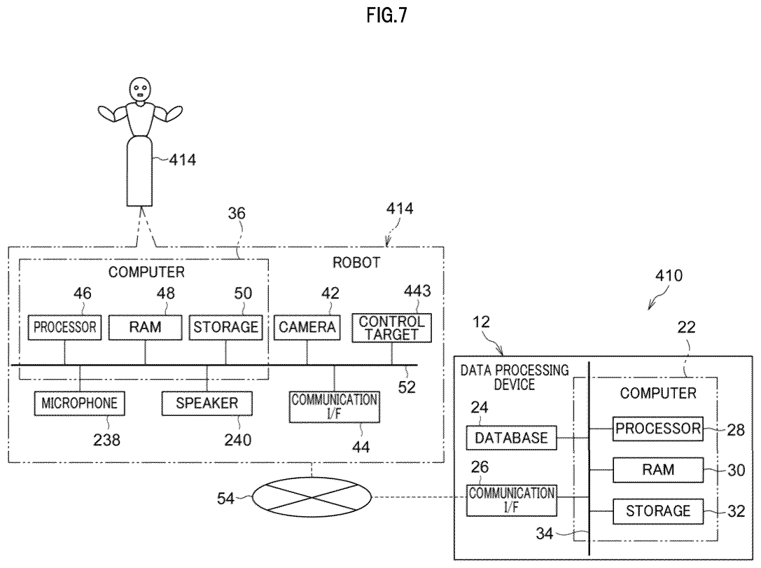

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

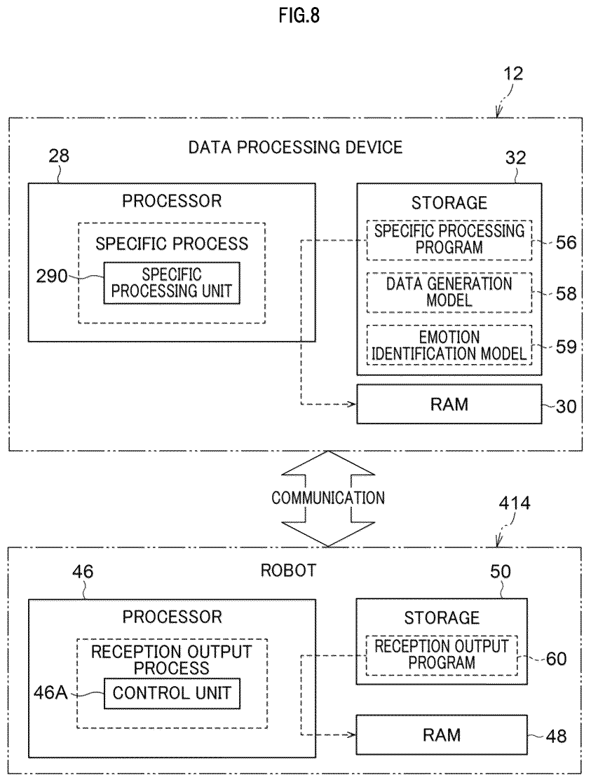

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

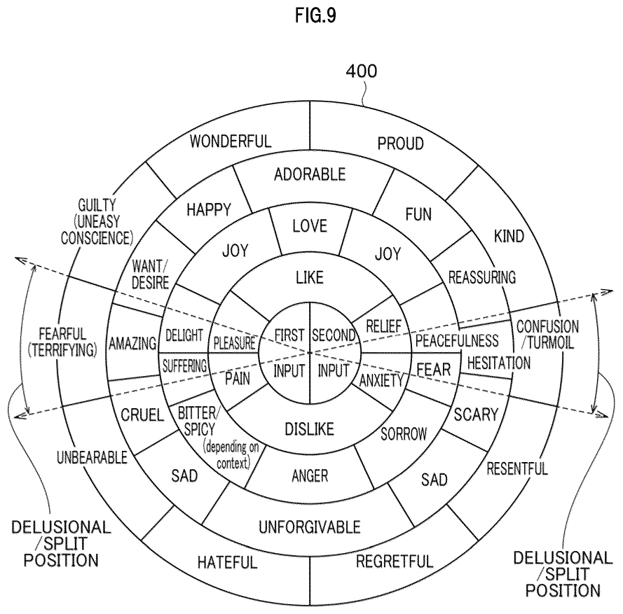

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

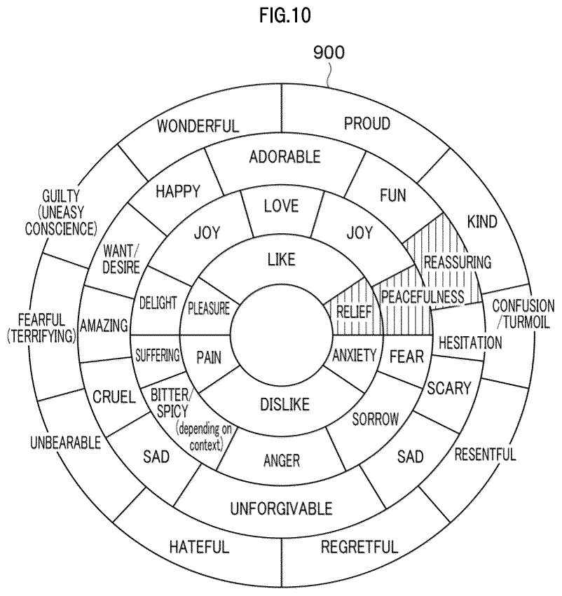

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire and record operation information including operation data related to an apparatus, so as to store the operation information in a storage unit,
transmit the recorded operation information to an information processing apparatus via a communication path, and receive control information or notification information from the information processing apparatus via the communication path,
analyze an operation state of the apparatus on the basis of the operation information by executing an analysis process including a learning process, and determine whether the operation state is a normal state or an abnormal state,
generate explanatory information or proposal information for a user in accordance with a determination result of the analysis process,
generate audio data by converting the explanatory information or the proposal information into output data suitable for audio output,
output the generated audio data to a user via an output device,
transmit a prompt sentence, which is an input sentence for causing a generative AI model to generate explanatory information for the user or configuration information for the analysis process, to the generative AI model, receive response information from the generative AI model, and update or correct at least one of the explanatory information and the configuration information for the analysis process on a basis of the response information, and
acquire state information or behavior detection information from another apparatus via the communication path, generate, on a basis of the state information or the behavior detection information, operation change proposal information for the user, output the operation change proposal information as audio data to the user, and control an operation of at least one apparatus in accordance with a user response to the operation change proposal information.

### Supplementary 2

The system according to supplementary 1,
wherein the processor is configured to use, as the operation information, at least one of a usage start time, a usage end time, energy consumption information, environmental information, abnormality identification information, warning information, and user operation history information, execute an abnormality detection process using a learning process so as to learn a normal operation pattern from the operation information, set a threshold for abnormal state determination on a basis of a deviation from the normal operation pattern, and adjust at least one of a processing procedure and a control condition relating to the abnormality detection process on a basis of response information acquired from the generative AI model.

### (Supplementary 3)

The system according to supplementary 1,
wherein the processor is configured to generate, as the prompt sentence, an input sentence including measurement information contained in the operation information and a determination result obtained by the analysis process, transmit the prompt sentence to the generative AI model to obtain a candidate of a voice notification sentence or a warning sentence for the user, create notification explanatory information including abnormality content and a countermeasure action on a basis of the obtained candidate, and convert the notification explanatory information into the audio data to be provided to the output device.

### Application Example 1

### Supplementary 1

A system comprising a processor,
wherein the processor is configured to acquire and record operation logs including biological information and behavioral information of assisted persons,
control communication of a terminal to transmit the operation logs to a server via a network, store the operation logs in the server and analyze the operation logs by using a machine learning algorithm to learn normal health-state patterns and to determine abnormal states based on the operation logs,
generate notification text according to a type and an urgency level of the abnormal states detected by the analysis, and synthesize a voice signal based on the notification text,
transmit the voice signal to at least one acoustic device or portable information device in a facility and cause output of the voice signal as an audio notification, and
transmit a prompt sentence to a generative artificial intelligence model in order to improve the machine learning algorithm or an abnormality determination condition used in the analysis, and update setting information of the machine learning algorithm or the abnormality determination condition based on a response from the generative artificial intelligence model.

### Supplementary 2

The system according to supplementary 1,
wherein the processor is configured to
include, in the operation logs, temperature information, heart-rate information, respiration-rate information, motion-pattern information, floor-pressure information, measurement time information, and assisted-person identification information,
preprocess the operation logs as time-series data, generate a normal-state model by the machine learning algorithm, detect at least one of fever, low heart rate, abnormal respiration, fall, and abnormal immobility as the abnormal states based on a degree of deviation from the normal-state model, and determine recommended response content and a priority level to be included in the notification text according to a type and a frequency of the detected abnormal states.

### Supplementary 3

The system according to supplementary 1,
wherein the processor is configured to
include, in the prompt sentence to be transmitted to the generative artificial intelligence model, statistical information of the operation logs, currently set abnormality detection conditions, and information on past false-alarm cases or missed-incident cases, and, based on the response obtained from the generative artificial intelligence model, automatically or semi-automatically adjust at least one of a threshold, a feature-extraction method, a model structure, and a notification-generation rule used by the analysis of the operation logs.

### Example 2

### Supplementary 1

A system comprising a processor,
wherein the processor is configured to record operation log data including time-series data and state data as recording means,
analyze the recorded operation log data by using a machine learning algorithm to determine an operating state of an apparatus as analysis means,
estimate an emotional state of a user on a basis of voice data acquired from the user, operation history data of the user, and environment information as emotion estimation means,
generate a prompt sentence to be input to a generative artificial intelligence model in accordance with the operating state determined by the analysis means and the emotional state estimated by the emotion estimation means, input the prompt sentence to the generative artificial intelligence model, and acquire a notification message output from the generative artificial intelligence model as notification message generation means,
generate an audio signal on a basis of the notification message acquired by the notification message generation means as audio generation means,
output the generated audio signal to the user as audio output means, and
transmit and receive information regarding the operation log data, the voice data, the operation history data, and the notification message to and from an external apparatus via a communication network to share information as communication means.

### Supplementary 2

The system according to supplementary 1,
wherein the processor is configured to
include, in the operation log data, at least start time information, end time information, power consumption information, environment information, error information, warning information, and the operation history data of the user,
learn a normal operating pattern by using the machine learning algorithm on a basis of the operation log data and set a criterion for detecting an abnormality as a function of the analysis means,
perform speech recognition processing on the voice data to convert the voice data into character string data, and estimate the emotional state and a stress state of the user on a basis of the character string data, the operation history data, and the environment information as a function of the emotion estimation means, and
cause the notification message generation means to generate the prompt sentence including output style information, information amount information, and expression condition information in accordance with the operating state and the emotional state.

### Supplementary 3

The system according to supplementary 1,
wherein the processor is configured to
cause the communication means to be connected to an external apparatus via the communication network and to receive location state information or behavior state information of the user from the external apparatus,
cause the notification message generation means, when the location state information or the behavior state information is received, to generate the prompt sentence including an energy-saving proposal or a safety proposal in accordance with the operating state and the emotional state, and to cause the generative artificial intelligence model to create the notification message including content of the proposal,
cause the audio generation means to generate the audio signal on a basis of the notification message including the content of the proposal,
cause the audio output means to output the audio signal to the user, and
control a power state or an operating state of the apparatus on a basis of response content of the user.

### Application Example 2

### Supplementary 1

A system comprising a processor,
wherein the processor is configured to
acquire operation information including biological information and behavioral information regarding a subject and record the operation information as time-series data,
perform numerical processing and feature extraction processing on the recorded operation information to generate a feature sequence including statistical indices and frequency components,
input the feature sequence to a machine learning model and determine presence or absence of an abnormality and a degree of the abnormality in a health state of the subject as a health state analysis result,
acquire emotion-related information including acoustic information and image information, and estimate an emotional state of the subject on a basis of the emotion-related information and the biological information and the behavioral information as an emotion analysis result, integrate the health state analysis result and the emotion analysis result to determine whether notification is required and to determine a notification priority, and construct a prompt sentence for input to a generative AI model on a basis of an integration result and attribute information of the subject,
transmit the constructed prompt sentence to the generative AI model, receive a response text from the generative AI model, and generate character information representing notification content on a basis of the response text,
convert the character information into an audio signal as a notification audio signal,
transmit the notification audio signal and the character information to an output device to provide a notification to a user,
transmit and receive data and analysis results used by the processor in acquiring and recording the operation information and in performing the health state analysis and the emotion analysis to and from another information processing apparatus via a communication network, and
update at least one of parameters and decision criteria of the machine learning model used in the health state analysis and the machine learning model used in the emotion analysis on a basis of a response obtained from the generative AI model and feedback information obtained from the user.

### Supplementary 2

The system according to supplementary 1,
wherein the processor is configured to
record, as the operation information, time-series data including, as the biological information, a body temperature value, a heart rate value, a respiration rate value, and a pressure sensor output, time-series data including, as the behavioral information, a movement state, a posture state, and an activity index, data including, as the acoustic information, a voice waveform and an acoustic feature sequence, and image data including, as the image information, a face region and a facial expression feature,
cause the machine learning model for the health state analysis to learn normal patterns and abnormal patterns of the health state on a basis of the time-series data, and
cause the machine learning model for the emotion analysis to estimate an emotion category and an emotion intensity on a basis of the acoustic information and the image information.

### Supplementary 3

The system according to supplementary 1,
wherein the processor is configured to
connect to a plurality of terminal devices via a wide area communication network,
when the processor determines in the integration result that the notification is required,
transmit the notification content generated by the processor to at least one of the plurality of terminal devices in a notification mode corresponding to the notification priority, receive feedback information relating to a response result and a situation at a site from the at least one of the plurality of terminal devices, and
use the feedback information to continuously improve analysis accuracy of the health state analysis and the emotion analysis.

What is claimed is:

1. A system comprising:
circuitry configured to:
acquire, via a communication interface coupled to a packet-switched network,
operation information relating to an apparatus;
execute an analysis process on the operation information to determine an operation state of the apparatus;
generate explanatory information on a basis of a result of the analysis process;
generate audio data from the explanatory information and transmit the audio data to a user terminal via the packet-switched network; and
acquire state information from another apparatus via the packet-switched network and share the state information with the another apparatus.

2. The system according to claim 1, wherein the analysis process comprises a learning process that learns a normal operation pattern from the operation information and determines whether the operation state is a normal state or an abnormal state on a basis of a deviation from the normal operation pattern.

3. The system according to claim 2, wherein the learning process comprises training an autoencoder neural network including an encoder that compresses a sequence of feature vectors derived from the operation information into a latent representation and a decoder that reconstructs the sequence from the latent representation, and the circuitry determines the operation state as the abnormal state when a reconstruction error computed between observed values and reconstructed values exceeds a threshold.

4. The system according to claim 3, wherein the circuitry is further configured to execute a tree-based anomaly detection algorithm on the operation information to assign an anomaly score, and to combine the reconstruction error and the anomaly score using an ensemble decision rule to determine whether the operation state is the normal state or the abnormal state.

5. The system according to claim 4, wherein the circuitry is further configured to execute rule-based checks on attributes in the operation information using vectorized operations, and to combine rule-based decisions with the ensemble decision rule to form a final determination of the operation state.

6. The system according to claim 1, wherein the circuitry is further configured to construct a prompt sentence including at least one of measurement information contained in the operation information and an analysis result from the analysis process, transmit the prompt sentence to a generative AI model, and receive response information from the generative AI model.

7. The system according to claim 6, wherein the circuitry is further configured to update configuration information for the analysis process on a basis of the response information by extracting threshold recommendations and parameter adjustment rules from the response information and storing the extracted threshold recommendations and parameter adjustment rules in a configuration data structure.

8. The system according to claim 7, wherein the circuitry is further configured to update the explanatory information on a basis of the response information by extracting a candidate notification text from the response information, executing filtering processing on the candidate notification text with respect to at least one of safety and expression style, and replacing the explanatory information with the candidate notification text when the candidate notification text satisfies a filtering criterion.

9. The system according to claim 1, wherein the circuitry is further configured to acquire behavior detection information indicating a detected behavior of a user from the another apparatus via the packet-switched network, and to generate operation change proposal information for the user on a basis of the behavior detection information.

10. The system according to claim 9, wherein the circuitry is further configured to generate audio data from the operation change proposal information and transmit the audio data to the user terminal, receive a user response to the operation change proposal information via the packet-switched network, and control an operation of at least one apparatus in accordance with the user response.

11. The system according to claim 10, wherein the behavior detection information comprises out-of-home detection information received from a smart door lock, and the operation change proposal information comprises a proposal to turn off power of at least one home appliance.

12. The system according to claim 1, wherein the operation information comprises at least one of a usage start time, a usage end time, energy consumption information, environmental information, abnormality identification information, warning information, and user operation history information.

13. The system according to claim 12, wherein the circuitry is further configured to preprocess the operation information by performing at least one of scaling, outlier removal, and segmentation into fixed-length time windows, and to generate feature vectors including normalized values derived from the operation information.

14. The system according to claim 1, wherein the circuitry is further configured to estimate an emotion of a user by applying an emotion identification model to at least one of voice data received from the user terminal, facial expression data extracted from image information, and text sentiment data derived from a user response, and to adjust a priority or a detail level of the explanatory information on a basis of the estimated emotion.

15. The system according to claim 14, wherein the circuitry is further configured to adjust prosodic parameters of the audio data on a basis of the estimated emotion, such that when the estimated emotion indicates anxiety, the circuitry reduces a speaking rate and increases a clarity parameter, and when the estimated emotion indicates calm, the circuitry increases a speaking rate.

16. The system according to claim 1, wherein the circuitry is further configured to generate the audio data by executing a text-to-speech engine that converts the explanatory information into synthesized speech with controllable parameters comprising at least one of a language, a speaking rate, and a volume level.

17. The system according to claim 1, wherein the circuitry is further configured to store processing history comprising at least one of analysis process data, notification generation data, and user response data for each interaction, and to update at least one of a parameter of the analysis process and content of a prompt sentence on a basis of accumulated processing history.

18. A system comprising:
circuitry configured to:
acquire, via a communication interface operating over a packet-switched network, operation information relating to an apparatus, the operation information comprising at least one of a usage start time, a usage end time, energy consumption information, environmental information, abnormality identification information, warning information, and user operation history information, and store the operation information in a time-series data structure;
preprocess the operation information by performing scaling and segmentation into fixed-length time windows to generate feature vectors, and execute an analysis process comprising a learning process on the feature vectors, the learning process comprising training an autoencoder neural network that compresses the feature vectors into a latent representation and reconstructs the feature vectors, and determining an operation state as an abnormal state when a reconstruction error exceeds a threshold determined from a distribution of reconstruction errors for normal operation data;
construct a prompt sentence including measurement information contained in the operation information and an analysis result from the analysis process, transmit the prompt sentence to a generative AI model implemented as a transformer-based language model, receive response information from the generative AI model, and update at least one of configuration information for the analysis process and explanatory information on a basis of the response information;
generate audio data from the explanatory information by executing a text-to-speech engine and transmit the audio data to a user terminal via the packet-switched network;
acquire behavior detection information from another apparatus via the packet-switched network, generate operation change proposal information on a basis of the behavior detection information, transmit the operation change proposal information as audio data to the user terminal, receive a user response, and control an operation of at least one apparatus in accordance with the user response; and
store processing history for each interaction and update at least one of a parameter of the analysis process and content of the prompt sentence on a basis of accumulated processing history.

19. The system according to claim 18, wherein the circuitry is further configured to estimate an emotion of a user by applying an emotion identification model to at least one of voice data received from the user terminal and facial expression data extracted from image information, and to adjust at least one of a priority of the explanatory information and prosodic parameters of the audio data on a basis of the estimated emotion.

20. A method performed by circuitry of a system, the method comprising:
acquiring, via a communication interface coupled to a packet-switched network, operation information relating to an apparatus;
executing an analysis process on the operation information to determine an operation state of the apparatus;
generating explanatory information on a basis of a result of the analysis process;
generating audio data from the explanatory information and transmitting the audio data to a user terminal via the packet-switched network; and
acquiring state information from another apparatus via the packet-switched network and sharing the state information with the another apparatus.
